(19) United States
(12) Patent Application Publication
(10) Pub. No.: US 2025/0142646 A1
(43) Pub. Date: May 1, 2025

(54) WIRELESS COMMUNICATION METHOD AND DEVICE

(71) Applicant: GUANGDONG OPPO MOBILE TELECOMMUNICATIONS CORP., LTD., Dongguan (CN)

(72) Inventors: Yang XU, Dongguan (CN); Jingran CHEN, Dongguan (CN)

(73) Assignee: GUANGDONG OPPO MOBILE TELECOMMUNICATIONS CORP., LTD., Dongguan (CN)

(21) Appl. No.: 19/006,768

(22) Filed: Dec. 31, 2024

Related U.S. Application Data
(63) Continuation of application No. PCT/CN2022/113422, filed on Aug. 18, 2022.

(51) Int. Cl. H04W 76/10; H04W 8/00; H04W 92/18

(52) U.S. Cl. CPC H04W 76/10; H04W 8/005; H04W 92/18

(57) ABSTRACT

Embodiments of this application provide a wireless communication method and a device. The wireless communication method is applied to a first terminal, the first terminal transmits related data of the first terminal by using a PDU session established between a second terminal and a network, and the method includes: transmitting, by the first terminal, first information, where the first information includes at least one of the following: identity information of the first terminal, an identity of a first PDU session, or first indication information, where the first PDU session is a PDU session established between the first terminal and the network, and the first indication information is used to indicate the second terminal to execute a proximity computing service.

### CROSS-REFERENCE TO RELATED APPLICATION

This application is a continuation of International Application No. PCT/CN2022/113422, filed on Aug. 18, 2022, the disclosure of which is hereby incorporated by reference in its entirety.

### TECHNICAL FIELD

Embodiments of this application relate to the communications field, and more specifically, to a wireless communication method and device.

### BACKGROUND

In a new radio (NR) system, a remote terminal (Remote UE) may access a network by using a relay terminal (Relay UE). The relay terminal (Relay UE) may provide not only a communication service but also a computing service (that is, a proximity computing service). However, how the relay terminal (Relay UE) specifically provides the proximity computing service for the remote terminal (Remote UE) is a problem that needs to be resolved.

### SUMMARY

Embodiments of this application provide a wireless communication method and device. For a service, a second terminal may share a part of computing tasks of a first terminal, that is, the second terminal may use a sidelink between the second terminal and the first terminal to unload a work task of a proximity-based service, so that computing load of the first terminal can be reduced, thereby optimizing service computing and transmission efficiency.

According to a first aspect, a wireless communication method is provided and applied to a first terminal. The first terminal transmits related data of the first terminal by using a PDU session established between a second terminal and a network, and the method includes:
transmitting, by the first terminal, first information,
where the first information includes at least one of the following: identity information of the first terminal, an identity of a first PDU session, or first indication information,
where the first PDU session is a PDU session established between the first terminal and the network, and the first indication information is used to indicate the second terminal to execute a proximity computing service.

According to a second aspect, a wireless communication method is provided and applied to a second terminal. A first terminal transmits related data of the first terminal by using a PDU session established between the second terminal and a network, and the method includes:
receiving, by the second terminal, first information,
where the first information includes at least one of the following: identity information of the first terminal, an identity of a first protocol data unit PDU session, or first indication information,
where the first PDU session is a PDU session established between the first terminal and the network, and the first indication information is used to indicate the second terminal to execute a proximity computing service.

According to a third aspect, a wireless communication method is provided and applied to a second terminal. The method includes:
transmitting, by the second terminal, second information,
where the second information includes at least one of the following: identity information of a first terminal, an identity of a first PDU session, or second indication information,
where the first PDU session is a PDU session established between the first terminal and a network, the second indication information is used to indicate to obtain address information of the first PDU session, and/or the second indication information is used to indicate to select a session management function SMF entity and/or a UPF entity serving the first PDU session.

According to a fourth aspect, a wireless communication method is provided and applied to an SMF entity. The method includes:
receiving, by the SMF entity, second information,
where the second information includes at least one of the following: identity information of a first terminal, an identity of a first PDU session, or second indication information,
where the first PDU session is a PDU session established between the first terminal and a network, the second indication information is used to indicate to obtain address information of the first PDU session, and/or the second indication information is used to indicate to select an SMF and/or a UPF serving the first PDU session.

According to a fifth aspect, a wireless communication method is provided and applied to a first terminal. The first terminal transmits related data of the first terminal by using a PDU session established between a second terminal and a network, and the method includes:
transmitting, by the first terminal, fourth information,
where the fourth information includes at least one of the following: information about a first computing task, information about a second computing task, a computing time of the first computing task, or a total time of a first service,
where the first computing task is executed by the first terminal, the second computing task is executed by the second terminal, and the first computing task, the second computing task, and a computing task executed by the network constitute the first service; and
the total time of the first service includes the computing time of the first computing task, a time for transmitting related data of the first computing task, a computing time of the second computing task, a time for transmitting related data of the second computing task, and a computing time of the computing task executed by the network.

According to a sixth aspect, a wireless communication method is provided and applied to a second terminal. A first terminal transmits related data of the first terminal by using a PDU session established between the second terminal and a network, and the method includes:
receiving, by the second terminal, fourth information,
where the fourth information includes at least one of the following: information about a first computing task, information about a second computing task, a computing time of the first computing task, or a total time of a first service,
where the first computing task is executed by the first terminal, the second computing task is executed by the second terminal, and the first computing task, the second computing task, and a computing task executed by the network constitute the first service; and
the total time of the first service includes the computing time of the first computing task, a time for transmitting related data of the first computing task, a computing time of the second computing task, a time for transmitting related data of the second computing task, and a computing time of the computing task executed by the network.

According to a seventh aspect, a terminal device is provided, configured to execute the method in the first aspect.

Specifically, the terminal device includes a functional module configured to execute the method in the first aspect.

According to an eighth aspect, a terminal device is provided, configured to execute the method in the second aspect.

Specifically, the terminal device includes a functional module configured to execute the method in the second aspect.

According to a ninth aspect, a terminal device is provided, configured to execute the method in the third aspect.

Specifically, the terminal device includes a functional module configured to execute the method in the third aspect.

According to a tenth aspect, an SMF entity is provided, configured to execute the method in the fourth aspect.

Specifically, the SMF entity includes a functional module configured to execute the method in the fourth aspect.

According to an eleventh aspect, a terminal device is provided, configured to execute the method in the fifth aspect.

Specifically, the terminal device includes a functional module configured to execute the method in the fifth aspect.

According to a twelfth aspect, a terminal device is provided, configured to execute the method in the sixth aspect.

Specifically, the terminal device includes a functional module configured to execute the method in the sixth aspect.

According to a thirteenth aspect, a terminal device is provided, including a processor and a memory. The memory is configured to store a computer program, and the processor is configured to invoke and run the computer program stored in the memory, to cause the terminal device to execute the method in the first aspect.

According to a fourteenth aspect, a terminal device is provided, including a processor and a memory. The memory is configured to store a computer program, and the processor is configured to invoke and run the computer program stored in the memory, to cause the terminal device to execute the method in the second aspect.

According to a fifteenth aspect, a terminal device is provided, including a processor and a memory. The memory is configured to store a computer program, and the processor is configured to invoke and run the computer program stored in the memory, to cause the terminal device to execute the method in the third aspect.

According to a sixteenth aspect, an SMF entity is provided, including a processor and a memory. The memory is configured to store a computer program, and the processor is configured to invoke and run the computer program stored in the memory, to cause the SMF entity to execute the method in the fourth aspect.

According to a seventeenth aspect, a terminal device is provided, including a processor and a memory. The memory is configured to store a computer program, and the processor is configured to invoke and run the computer program stored in the memory, to cause the terminal device to execute the method in the fifth aspect.

According to an eighteenth aspect, a terminal device is provided, including a processor and a memory. The memory is configured to store a computer program, and the processor is configured to invoke and run the computer program stored in the memory, to cause the terminal device to execute the method in the sixth aspect.

According to a nineteenth aspect, an apparatus is provided, configured to implement the method in any one of the first aspect to the sixth aspect.

Specifically, the apparatus includes a processor, configured to invoke and run a computer program in a memory, to cause a device installed with the apparatus to execute the method in any one of the first aspect to the sixth aspect.

According to a twentieth aspect, a computer-readable storage medium is provided, configured to store a computer program. The computer program causes a computer to execute the method in any one of the first aspect to the sixth aspect.

According to a twenty-first aspect, a computer program product is provided, including computer program instructions. The computer program instructions cause a computer to execute the method in any one of the first aspect to the sixth aspect.

According to a twenty-second aspect, a computer program is provided, and when being run on a computer, the computer program causes the computer to execute the method in any one of the first aspect to the sixth aspect.

### BRIEF DESCRIPTION OF DRAWINGS

FIG. 1 is a schematic diagram of a communications system architecture to which embodiment of this application are applied.

FIG. 2 is a schematic diagram of a procedure of establishing a relay service-related connection according to this application.

FIG. 3 is a schematic diagram of hierarchical computing/communication resource evaluation of an AlexNet model according to this application.

FIG. 4 is a schematic diagram of model computing without task offloading according to this application.

FIG. 5 is a schematic diagram of model computing with task offloading according to this application.

FIG. 6 is a schematic interactive flowchart of a wireless communication method according to an embodiment of this application.

FIG. 7 is a schematic interactive flowchart of another wireless communication method according to an embodiment of this application.

FIG. 8 is a schematic interactive flowchart of still another wireless communication method according to an embodiment of this application.

FIG. 9 is a schematic flowchart in which an IP address remains unchanged before and after UE 2 participates in a proximity computing service according to an embodiment of this application.

FIG. 10 is a schematic interactive flowchart of still another wireless communication method according to an embodiment of this application.

FIG. 11 is a schematic block diagram of a terminal device according to an embodiment of this application.

FIG. 12 is a schematic block diagram of another terminal device according to an embodiment of this application.

FIG. 13 is a schematic block diagram of still another terminal device according to an embodiment of this application.

FIG. 14 is a schematic block diagram of an SMF entity according to an embodiment of this application.

FIG. 15 is a schematic block diagram of still another terminal device according to an embodiment of this application.

FIG. 16 is a schematic block diagram of still another terminal device according to an embodiment of this application.

FIG. 17 is a schematic block diagram of a communications device according to an embodiment of this application.

FIG. 18 is a schematic block diagram of an apparatus according to an embodiment of this application.

FIG. 19 is a schematic block diagram of a communications system according to an embodiment of this application.

### DESCRIPTION OF EMBODIMENTS

The following describes the technical solutions in embodiments of this application with reference to the accompanying drawings in embodiments of this application. Apparently, the described embodiments are some rather than all of embodiments of this application. All other embodiments obtained by a person of ordinary skill in the art based on embodiments of this application without creative efforts shall fall within the protection scope of this application.

The technical solutions in embodiments of this application may be applied to various communications systems, for example, a global system for mobile communications (GSM), a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunications system (UMTS), a wireless local area network (WLAN), internet of things (IoT), wireless fidelity (WiFi), a fifth-generation (5th-Generation, 5G) system, a sixth-generation (6th-Generation, 6G) system, or another communications system.

Generally, a quantity of connections supported by a conventional communications system is limited and is also easy to implement. However, with development of communications technologies, a mobile communications system not only supports conventional communication, but also supports, for example, device-to-device (D2D) communication, machine-to-machine (M2M) communication, machine type communication (MTC), vehicle-to-vehicle (V2V) communication, sidelink (SL) communication, or vehicle-to-everything (V2X) communication. Embodiments of this application may also be applied to these communications systems.

In some embodiments, a communications system in embodiments of this application may be applied to a carrier aggregation (CA) scenario, a dual connectivity (DC) scenario, a standalone (SA) networking scenario, or a non-standalone (NSA) networking scenario.

In some embodiments, a communications system in embodiments of this application may be applied to an unlicensed spectrum, and the unlicensed spectrum may also be considered as a shared spectrum. Alternatively, a communications system in embodiments of this application may be applied to a licensed spectrum, and the licensed spectrum may also be considered as a non-shared spectrum.

In some embodiments, a communications system in embodiments of this application may be applied to an FR1 frequency band (corresponding to a frequency band range 410 MHz to 7.125 GHz), or may be applied to an FR2 frequency band (corresponding to a frequency band range 24.25 GHz to 52.6 GHz), or may be applied to a new frequency band corresponding to, for example, a frequency band range 52.6 GHz to 71 GHZ, or a high frequency band corresponding to a frequency band range 71 GHz to 114.25 GHz.

Embodiments of this application are described with reference to a network device and a terminal device. The terminal device may also be referred to as user equipment (UE), an access terminal, a subscriber unit, a subscriber station, a mobile site, a mobile station, a remote station, a remote terminal, a mobile device, a user terminal, a terminal, a wireless communications device, a user agent, a user apparatus, or the like.

The terminal device may be a station (ST) in a WLAN, or may be a cellular phone, a cordless phone, a session initiation protocol (SIP) phone, a wireless local loop (WLL) station, a personal digital assistant (PDA) device, a handheld device having a wireless communication function, a computing device or another processing device connected to a wireless modem, a vehicle-mounted device, a wearable device, a terminal device in a next generation communications system such as an NR network, a terminal device in a future evolved public land mobile network (PLMN), or the like.

In embodiments of this application, the terminal device may be deployed on land, including being indoors or outdoors, handheld, wearable, or vehicle-mounted. The terminal device may also be deployed on water (for example, on a ship), or may be deployed in the air (for example, on an airplane, an air balloon, or a satellite).

In embodiments of this application, the terminal device may be a mobile phone, a tablet computer (Pad), a computer with a wireless transceiver function, a virtual reality (VR) terminal device, an augmented reality (AR) terminal device, a wireless terminal device in industrial control, a wireless terminal device in self driving, a wireless terminal device in remote medical (remote medical), a wireless terminal device in smart grid, a wireless terminal device in transportation safety, a wireless terminal device in smart city, or a wireless terminal device in smart home, a vehicle-mounted communications device, a wireless communications chip/application specific integrated circuit (ASIC)/system on chip (SoC), or the like.

By way of example rather than limitation, in embodiments of this application, the terminal device may alternatively be a wearable device. The wearable device may also be referred to as a smart wearable device, and is a general term for wearable devices, such as glasses, gloves, watches, clothes, and shoes, that are intelligently designed and developed based on daily wearing by using a wearable technology. The wearable device is a portable device that can be directly worn or integrated into clothes or accessories of a user. In addition to being a hardware device, the wearable device can also realize various functions through software support, data interaction, and cloud interaction. In a broad sense, the wearable smart device includes a full-featured and large-sized device that can implement some or all of functions without relying on a smartphone, for example, a smart watch or smart glasses, and a device that only focuses on a specific type of application function and needs to cooperate with another device such as a smartphone, for example, various smart bracelets and smart jewelries for physical sign monitoring.

In embodiments of this application, the network device may be a device configured to communicate with a mobile device. The network device may be an access point (AP) in a WLAN, may be a base transceiver station (BTS) in GSM or CDMA, may be a NodeB (NB) in WCDMA, or may be an evolutional NodeB (eNB or eNodeB) in LTE, or a relay station or an access point, or a vehicle-mounted device, a wearable device, a network device or a gNB or a transmission reception point (TRP) in an NR network, or a network device in a future evolved PLMN, or a network device in an NTN, or the like.

By way of example rather than limitation, in embodiments of this application, the network device may have a mobility characteristic. For example, the network device may be a mobile device. In some embodiments, the network device may be a satellite or a balloon station. For example, the satellite may be a low earth orbit (LEO) satellite, a medium earth orbit (MEO) satellite, a geostationary earth orbit (GEO) satellite, or a high elliptical orbit (HEO) satellite. In some embodiments, the network device may alternatively be a base station disposed in a location such as land or water.

In embodiments of this application, the network device may provide a service for a cell. The terminal device communicates with the network device by using a transmission resource (for example, a frequency domain resource or a spectrum resource) used by the cell. The cell may be a cell corresponding to the network device (for example, a base station). The cell may belong to a macro station or may belong to a base station corresponding to a small cell. The small cell herein may include a metro cell, a micro cell, a pico cell, a femto cell, or the like. These small cells have characteristics of a small coverage range and low transmit power, and are applicable to providing a high-rate data transmission service.

For example, FIG. 1 shows a communications system 100 to which embodiments of this application are applied. The communications system 100 may include a first terminal 110, a second terminal 120, and a network device 130. The first terminal 110 may be connected to the network device 130 by using the second terminal 120, and the network device 130 may be a device that communicates with the second terminal 120 (or referred to as a communications terminal or a terminal). The network device 130 may provide communication coverage for a specific geographical region, and may communicate with a terminal device within the coverage region.

Optionally, in embodiments of this application, the first terminal 110 may be a remote terminal (Remote UE), and the second terminal 120 may be a relay terminal (Relay UE).

In some embodiments, the communications system 100 may include a plurality of network devices, and another quantity of terminal devices may be included in coverage of each network device, which is not limited in embodiments of this application.

In some embodiments, the communications system 100 may further include other network entities such as a network controller, a mobility management entity (for example, an access and mobility management function (AMF) entity), and a session management entity (for example, a session management function (SMF) entity), which is not limited in embodiments of this application.

It should be understood that in embodiments of this application, a device having a communication function in a network/system may be referred to as a communications device. Using the communications system 100 shown in FIG. 1 as an example, the communications device may include the first terminal 110, the second terminal 120, and the network device 130 having a communications function. The communications device may further include other devices in the communications system 100, for example, other network entities such as the network controller and the mobility management entity, which is not limited in embodiments of this application.

It should be understood that the terms “system” and “network” in this specification may often be used interchangeably in this specification. In this specification, the term “and/or” is merely an association that describes associated objects, and indicates that three relationships may exist. For example, A and/or B may represent three cases: only A exists, both A and B exist, and only B exists. In addition, the character “/” herein generally indicates an “or” relationship between associated objects.

It should be understood that this specification relates to a first communications device and a second communications device. The first communications device may be a terminal device, for example, a mobile phone, a machine facility, customer premise equipment (CPE), an industrial device, or a vehicle, and the second communications device may be a peer communications device of the first communications device, for example, a network device, a mobile phone, an industrial device, or a vehicle. In embodiments of this application, the first communications device may be a first terminal, and the second communications device may be a second terminal (that is, sidelink communication).

The terms used in implementations of this application are only used to illustrate specific embodiments of this application, but not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

It should be understood that, the “indication” mentioned in embodiments of this application may be a direct indication or an indirect indication, or indicate an association relationship. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B.

In the descriptions of embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, “predefined” or “preconfigured” may be implemented by prestoring corresponding code or a corresponding table in a device (for example, including a terminal device and a network device) or in other manners that can be used for indicating related information, and a specific implementation thereof is not limited in this application. For example, being predefined may refer to being defined in a protocol.

In embodiments of this application, the “protocol” may refer to a standard protocol in the communications field, and may be, for example, evolution of an existing LTE protocol, an NR protocol, a Wi-Fi protocol, or a protocol related to another related communications system. A type of the protocol is not limited in this application.

For ease of understanding of the technical solutions in embodiments of this application, the technical solutions of this application are described in detail below by using specific examples. The following related technologies, as optional solutions, may be randomly combined with the technical solutions of embodiments of this application, all of which fall within the protection scope of embodiments of this application. Embodiments of this application include at least part of the following content.

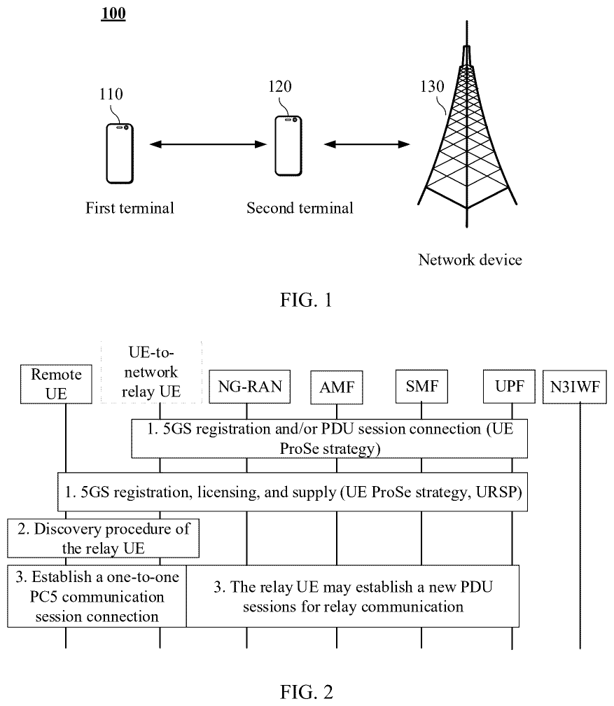

To better understand embodiments of this application, a relay connection establishment procedure related to this application is described. Specifically, as shown in FIG. 2, a relay connection may be executed by the following entity devices: remote UE, UE-to-network relay UE (UE-to-NW Relay UE), a next generation radio access network (NG-RAN), an access and mobility management function (AMF), a session management function (SMF), a user plane function (UPF), and a non-3GPP inter working function (N3IWF), where a connection between the remote UE and the relay UE is a layer 3 (L3).

Specifically, as shown in FIG. 2, in step 1, service authorization and configuration are executed for 5G proximity-based service (ProSe) L3 relay UE, and service authorization and configuration are executed for 5G ProSe L3 remote UE.

Specifically, as shown in FIG. 2, in step 2, the 5G ProSe L3 remote UE executes discovery of the 5G ProSe L3 relay UE. As a part of the discovery process, the 5G ProSe L3 remote UE learns of a connection service provided by the 5G ProSe L3 relay UE.

Specifically, as shown in FIG. 2, in step 3, the 5G ProSe L3 remote UE selects the 5G ProSe L3 relay UE and establishes a connection for unicast mode communication. If there is no protocol data unit (PDU) session associated with a relay service code or a new PDU session is required for relay, the 5G ProSe L3 relay UE starts an establishment process of the new PDU session for relay before completing PC5 connection establishment.

A network determines that a PDU session to be established is used to relay traffic, and then generates a quality of service (QOS) rule and a QoS parameter at a QoS flow level at the 5G ProSe L3 relay UE. The 5G ProSe L3 relay UE determines a type of the PDU session used for relay. In addition, the relay UE may further establish a PDU session, and the PDU session may be used to execute a relay service for the remote UE.

To better understand embodiments of this application, a model splitting-based inference method related to this application is described.

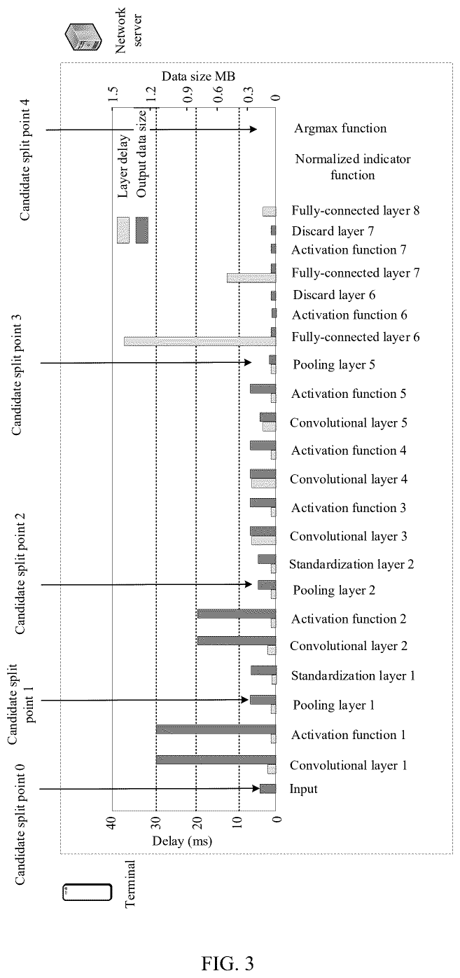

Model splitting is the most important feature of artificial intelligence (AI) inference. Specifically, in a convolutional neural network (CNN) used for image recognition, for example, an AlexNet model, different model split points may correspond to different quantities of layers computed by a terminal and different amounts of data transmission. For example, as shown in FIG. 3, a general trend is that the more layers the terminal computes, the less intermediate data needs to be transmitted to a network server (for example, an application server). In other words, when a computing capability of the terminal is relatively low (for example, due to insufficient battery power), the application server may change a split point so that the terminal computes fewer layers, and a data rate of a Uu interface is increased, so that intermediate data of higher load is transmitted to the network.

However, sometimes due to a limitation on radio resources, the data rate cannot be increased. In this case, the terminal with a relatively low computing capability needs to offload a computing task to a neighboring terminal (for example, a relay terminal, so as to provide a computing service), so that the neighboring terminal transmits computed data to the network. Therefore, the working task is offloaded through a device direct connection, so that original computing load of the terminal can be released, and the data rate of the Uu interface does not necessarily increase, thereby obtaining a better result.

To better understand embodiments of this application, a technical problem to be resolved in this application is described.

A remote terminal (Remote UE) may access a network by using a relay terminal (Relay UE). The relay terminal (Relay UE) may provide not only a communication service but also a computing service (that is, a proximity computing service). The “proximity computing service” means that the relay terminal (Relay UE) may provide not only a relay communication service, but also computing power so as to provide a computing service for a task, and send a computing result to a network server (for example, an application server).

However, how the relay terminal (Relay UE) specifically implements the proximity computing service is a problem that needs to be resolved.

Based on the foregoing problem, this application provides a wireless communication solution. In a case that a first terminal accesses a network by using a second terminal and the second terminal supports a proximity computing service, for a first service, the second terminal may share a part of computing tasks of the first terminal, that is, the second terminal may use a sidelink between the second terminal and the first terminal to unload a work task of a proximity-based service, so that computing load of the first terminal can be reduced, thereby optimizing computing and transmission efficiency of the first service.

In embodiments of this application, the first terminal (for example, UE-A) accesses the network by using the second terminal (for example, UE-B), and the second terminal (for example, UE-B) supports the proximity computing service. Specifically, the “proximity computing service” means that the second terminal (for example, UE-B) may provide not only a relay communication service, but also computing power so as to provide a computing service for a task, and send a computing result to a network server (for example, an application server). The following describes the proximity computing service provided by the second terminal (for example, UE-B) by using a specific embodiment.

The UE-A is using an AI model (for example, AlexNet) for image recognition. As shown in FIG. 3, the application server may pre-determine five candidate split points, which are respectively denoted as: a split point 0 (cloud-based inference), a split point 1 (after a pooling layer 1), a split point 2 (after a pooling layer 2), a split point 3 (after a pooling layer 5), and a split point 4 (device-based inference). Intermediate data sizes (for example, approximate output data size) and uplink data transmission rates (Required UL data rate) corresponding to the five candidate split points may be shown in Table 1. Fewer layers to compute means less load of work tasks for the UE-A to execute.

TABLE 1

| | Intermediate | Uplink data |
|---|---|---|
| | data size | transmission rate |
| Split point (Split point) | (MByte) | (Mbit/s) |
| Split point 0 | 0.15 | 36 |
| (Cloud-based inference) | | |
| Split point 1 | 0.27 | 65 |
| (after pooling layer 1) | | |
| Split point 2 | 0.17 | 41 |
| (after pooling layer 2) | | |
| Split point 3 | 0.02 | 4.8 |
| (after pooling layer 5) | | |
| Split point 4 | Not applicable | Not applicable |
| (Device-based inference) | (N/A) | (N/A) |

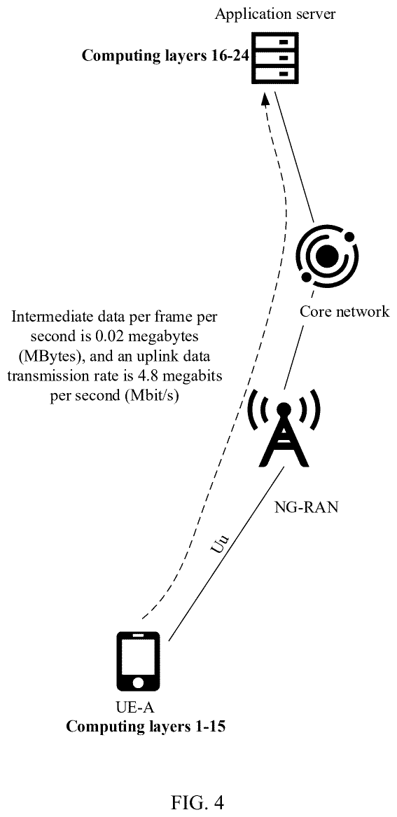

1. As shown in FIG. 4, the UE-A is using the Alexnet model for image recognition, and selects the split point 3 for AI inference, that is, intermediate data per frame per second is 0.02 MByte, and an uplink data transmission rate is 4.8 Mbit/s. Specifically, an end-to-end service delay (including an image recognition delay and an intermediate data transmission delay) is 1 second, that is, a time for which the UE-A executes computing tasks at layers 1 to 15 of the Alexnet model+a time for transmitting related data of the computing tasks at the layers 1 to 15 of the Alexnet model+a time for which the application server executes computing tasks at layers 16 to 24 of the Alexnet model=1 second.

2. When a battery level of the UE-A is low, the UE-A cannot undertake heavy work tasks of the AlexNet model (that is, computing the computing tasks at the layers 1 to 15 of the Alexnet model for the AlexNet model locally).

3. The UE-A discovers that the UE-B (for example, customer premise equipment (CPE)) installed with the same model (that is, the AlexNet model) is willing to share computing tasks from the UE-A.

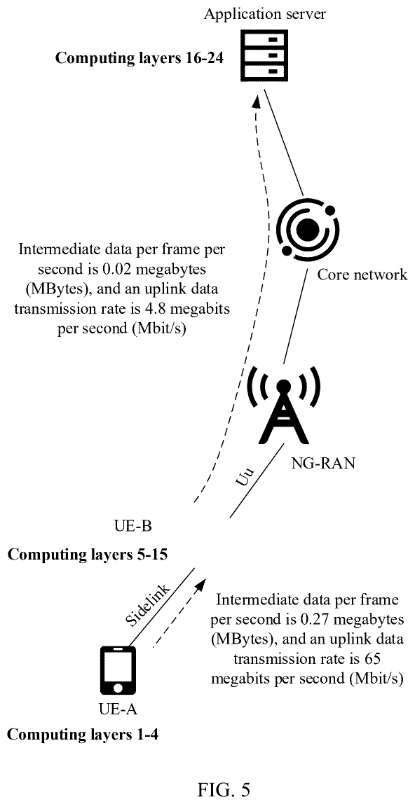

Specifically, as shown in FIG. 5, the UE-A establishes a sidelink (which may also be referred to as a straight-through connection or a direct device connection) between the UE-A and the UE-B. In the sidelink establishment process, the UE-B may further obtain information such as a total end-to-end service delay (including an image recognition delay and an intermediate data transmission delay) and a computing time consumed by the UE-A to compute layers 1 to 4 of the Alexnet model. Because the UE-B has obtained the total end-to-end service delay and the computing time consumed by the UE-A to compute the layers 1 to 4 of the Alexnet model, and the UE-B knows a computing time for computing layers 5 to 15 of the Alexnet model by the UE-B, the UE-B may determine a QoS parameter of a Uu interface (an interface between the UE-B and an NG-RAN) and a QoS parameter of a PC5 interface (an interface between the UE-B and the UE-A), and maintain that the total end-to-end service delay for image recognition in FIG. 5 is the same as the total end-to-end service delay for image recognition in FIG. 4.

It should be noted that it is assumed that the UE-A and the UE-B have a same computing capability, that is, a time used to compute some layers of the AlexNet model is the same for the UE-A and the UE-B. Otherwise, data rates of the Uu interface and the PC5 interface may change accordingly.

4. The UE-A transmits intermediate data (data obtained after computing the layers 1 to 4 of the Alexnet model) to the UE-B by using a sidelink, so that the UE-B further performs computing (that is, computes the layers 5 to 15 of the Alexnet model). Then the UE-B transmits, to the application server by using the Uu interface, the intermediate data computed by the UE-A (data obtained after computing the layers 1 to 4 of the Alexnet model) and intermediate data computed by the UE-B (data obtained after computing the layers 5-15 of the Alexnet model). A specific model layer computed by the UE-A and the UE-B is shown in FIG. 5. A direct device connection (that is, a sidelink) is used to implement offloading of a proximity-based work task. In this case, a data rate of the Uu interface of the UE-A does not need to be increased, and computing load of the UE-A is offloaded.

5. The UE-A continues to perform image recognition by using a sidelink and a computing capability of the UE-B, and an end-to-end service delay for image recognition remains unchanged.

The following describes the technical solutions in this application in detail by using specific embodiments.

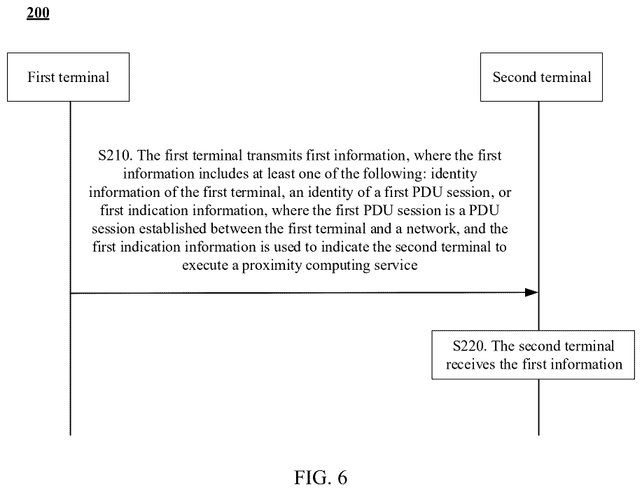

FIG. 6 is a schematic flowchart of a wireless communication method 200 according to an embodiment of this application. A first terminal transmits related data of the first terminal by using a PDU session established between a second terminal and a network. Specifically, as shown in FIG. 6, the wireless communication method 200 may include at least a part of the following content.

S210. The first terminal transmits first information, where the first information includes at least one of the following: identity information of the first terminal, an identity of a first PDU session, or first indication information, where the first PDU session is a PDU session established between the first terminal and the network, and the first indication information is used to indicate the second terminal to execute a proximity computing service.

S220. The second terminal receives the first information.

In this embodiment of this application, the second terminal may support a proximity computing service, that is, the second terminal may provide not only a relay communications service, but also computing power so as to provide a computing service for a task, and send a computing result to an application server.

In some embodiments, the first terminal may be a remote terminal, and the second terminal may be a relay terminal.

In some embodiments, before the second terminal executes the proximity computing service (that is, before the second terminal participates in a computing task), a computing task executed by the first terminal and a computing task executed by the network constitute a first service. Specifically, for example, as shown in FIG. 4, the computing task executed by the first terminal is computing tasks at layers 1 to 15 of an Alexnet model, the computing task executed by the network (that is, an application server) is computing tasks at layers 16 to 24 of the Alexnet model, and the computing tasks at the layers 1 to 24 of the Alexnet model constitute a first task (that is, an image recognition task).

In some embodiments, after the second terminal executes the proximity computing service (that is, after the second terminal participates in a computing task), a computing task executed by the first terminal, a computing task executed by the second terminal, and a computing task executed by the network constitute the first service. Specifically, for example, as shown in FIG. 5, the computing task executed by the first terminal is computing tasks at layers 1 to 4 of an Alexnet model, the computing task executed by the second terminal is computing tasks at layers 5 to 15 of the Alexnet model, the computing task executed by the network (that is, an application server) is computing tasks at layers 16 to 24 of the Alexnet model, and the computing tasks at the layers 1 to 24 of the Alexnet model constitute a first task (that is, an image recognition task).

In some embodiments, the first service may be an image recognition task, a measurement task, a positioning task, or the like. This is not limited in this embodiment of this application.

In some embodiments, the identity information of the first terminal includes at least an identity used by the first terminal in a core network or a layer 2 identity of the first terminal.

In some embodiments, in a case that the identity information of the first terminal includes at least the layer 2 identity of the first terminal, the second terminal or a core network device may determine, based on the layer 2 identity of the first terminal, the identity used by the first terminal in the core network.

In some embodiments, the identity used by the first terminal in the core network may include but is not limited to at least one of the following:
a subscription permanent identifier (SUPI), or a 5G globally unique temporary UE identity (5G-GUTI).

It should be noted that the identity information of the first terminal may further include another identity of the first terminal. This is not limited in this embodiment of this application.

In some embodiments, the first PDU session may be specifically a PDU session requested by the first terminal to be established before the second terminal participates in a computing task and used for transmitting related data of the computing task executed by the first terminal.

It should be understood that the first terminal may have a plurality of PDU sessions. In this embodiment, only the first PDU session is used for description, and another PDU session is not affected.

In this embodiment of this application, the first indication information is used to indicate the second terminal to execute the proximity computing service, and further, the second terminal may trigger a PDU session establishment or modification procedure, and obtain an internet protocol (IP) address previously used by the first terminal (that is, an IP address of the first PDU session). Further, the second terminal transmits related data of a computing task by using the IP address previously used by the first terminal, so as to ensure that an IP address used when the second terminal transmits the related data of the computing task remains unchanged before and after the second terminal participates in the computing task, and the network can also identify the related data of the computing task and transmitted after the second terminal participates in the computing task.

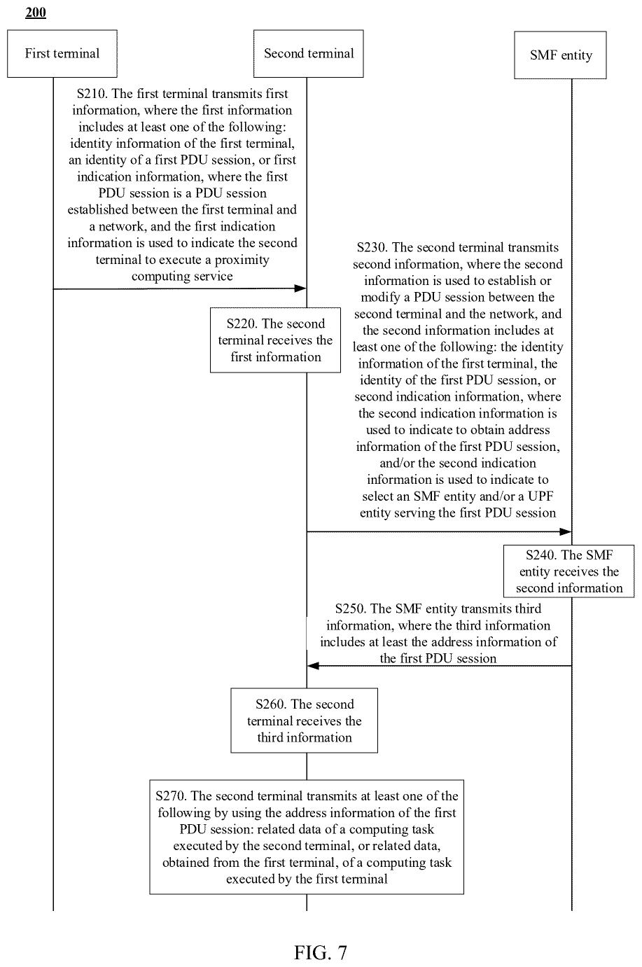

Further, optionally, as shown in FIG. 7, the wireless communication method 200 may further include at least a part of the following content.

S230. The second terminal transmits second information, where the second information is used to establish or modify the PDU session between the second terminal and the network, and the second information includes at least one of the following: the identity information of the first terminal, the identity of the first PDU session, or second indication information, where the second indication information is used to indicate to obtain address information of the first PDU session, and/or the second indication information is used to indicate to select an SMF entity and/or a UPF entity serving the first PDU session.

S240. An SMF entity receives the second information.

S250. The SMF entity transmits third information, where the third information includes at least the address information of the first PDU session.

S260. The second terminal receives the third information.

S270. The second terminal transmits at least one of the following by using the address information of the first PDU session: related data of a computing task executed by the second terminal, or related data, obtained from the first terminal, of a computing task executed by the first terminal.

Specifically, the SMF entity in S240 is the SMF entity serving the first PDU session.

Specifically, in S270, an address used when the second terminal transmits the related data of the computing task executed by the second terminal and/or the related data of the computing task executed by the first terminal is the address information of the first PDU session.

In some embodiments, the address information of the first PDU session may be one of the following: an internet protocol (IP) address, an IP v6 address, or a media access control (MAC) address.

In this embodiment of this application, the second terminal may indicate, based on content included in the first information, to obtain the address information of the first PDU session, and further, the second terminal may transmit at least one of the following by using the address information of the first PDU session: the related data of the computing task executed by the second terminal, or the related data, obtained from the first terminal, of the computing task executed by the first terminal. Specifically, the second terminal transmits related data of a computing task by using the address information of the first PDU session, so as to ensure that an address used when the second terminal transmits the related data of the computing task remains unchanged before and after the second terminal participates in the computing task, and the network can also identify the related data of the computing task and transmitted after the second terminal participates in the computing task.

In some embodiments, load of the computing task executed by the first terminal and load of the computing task executed by the second terminal may be determined by the first terminal and indicated to the second terminal. Alternatively, load of the computing task executed by the first terminal and load of the computing task executed by the second terminal may be determined by the first terminal and the second terminal through negotiation.

In some embodiments, the first terminal transmits the first information after a discovery procedure, that is, after discovering the second terminal, the first terminal may transmit the first information to the second terminal. Specifically, the discovery procedure may be shown in FIG. 2.

In some embodiments, the first terminal transmits the first information in a process of establishing a sidelink connection to the second terminal. Optionally, for example, the first information is carried by using a direct communication request, that is, the first terminal may carry the first information in the direct communication request transmitted in the process of establishing the sidelink connection to the second terminal.

In some embodiments, the first terminal transmits the first information after establishing a sidelink connection (which may also be referred to as a PC5 connection) to the second terminal. Optionally, for example, the first information is carried by using a PC5 user plane message. Specifically, the PC5 connection establishment procedure may be shown in FIG. 2.

In some embodiments, each computing task of the first service is executed by a first model. Optionally, the first model is an Alexnet model, or the first model is another network model. This is not limited in this embodiment of this application.

In some embodiments, model information of the first model is obtained by the first terminal in a registration process. For example, the model information of the first model is obtained by the first terminal in a process of executing fifth-generation system (5G system, 5GS) registration. Specifically, the 5GS registration process may be shown in FIG. 2.

In some embodiments, model information of the first model is preconfigured by a network device, or model information of the first model is stipulated in a protocol.

In some embodiments, the model information of the first model includes but is not limited to at least one of the following: a model topology and parameter information of the first model, model split point information of the first model, or an amount of intermediate data corresponding to a model split point of the first model.

Specifically, for example, the amount of the intermediate data corresponding to the model split point of the first model may be shown in the foregoing Table 1.

In some embodiments, the first terminal discovers the second terminal based on at least one of the following:
whether the first model is supported, or whether the proximity computing service is supported.

In some embodiments, the second information is carried by using one of the following: a PDU session establishment request, or a PDU session modification request.

Specifically, the PDU session establishment procedure may be shown in FIG. 2.

Specifically, for example, the second terminal may request, by transmitting a PDU session establishment request, to establish a new PDU session denoted as a second PDU session. Address information of the second PDU session is the address information of the first PDU session, and the second PDU session is used to transmit at least one of the following: related data of a computing task executed by the second terminal, or related data, obtained from the first terminal, of a computing task executed by the first terminal. The address information is, for example, an IP address.

Specifically, for example, the second terminal may request, by transmitting a PDU session establishment request, to establish a new PDU session denoted as a second PDU session. The second PDU session may be a PDU session that is the same as the first PDU session, address information corresponding to the second PDU session is the address information of the first PDU session, and the second PDU session is used to transmit at least one of the following: related data of a computing task executed by the second terminal, or related data, obtained from the first terminal, of a computing task executed by the first terminal. The address information is, for example, an IP address.

Specifically, for another example, the second terminal may request, by transmitting a PDU session modification request, to modify an original PDU session denoted as a third PDU session. Address information of the modified third PDU session is the address information of the first PDU session, and the modified third PDU session is used to transmit at least one of the following: related data of a computing task executed by the second terminal, or related data, obtained from the first terminal, of a computing task executed by the first terminal. The address information is, for example, an IP address.

In some embodiments, in a case that the second information is carried in a PDU session establishment request, the third information is carried in a PDU session establishment response; and/or in a case that the second information is carried in a PDU session modification request, the third information is carried in a PDU session modification response.

In some embodiments, the first terminal triggers release of the first PDU session. That is, after the second terminal participates in the computing task, the first terminal may transmit, by using the second terminal, the related data of the computing task executed by the first terminal. Therefore, the first terminal may trigger release of the first PDU session.

In some embodiments, the SMF entity triggers release of the first PDU session. That is, after the second terminal participates in the computing task, the first terminal may transmit, by using the second terminal, the related data of the computing task executed by the first terminal. Therefore, the SMF may trigger release of the first PDU session.

Therefore, in this embodiment of this application, the first terminal transmits the first information. Therefore, the second terminal may indicate, based on content included in the first information, to obtain the address information of the first PDU session, and further, the second terminal may transmit at least one of the following by using the address information of the first PDU session: the related data of the computing task executed by the second terminal, or the related data, obtained from the first terminal, of the computing task executed by the first terminal. Specifically, the second terminal transmits related data of a computing task by using the address information of the first PDU session, so as to ensure that address information used when the second terminal transmits the related data of the computing task remains unchanged before and after the second terminal participates in the computing task, and the network can also identify the related data of the computing task and transmitted after the second terminal participates in the computing task. That is, in a case that the first terminal accesses the network by using the second terminal and the second terminal supports the proximity computing service, for the first service, the second terminal may share a part of computing tasks of the first terminal, and the second terminal may use a sidelink between the second terminal and the first terminal to unload a work task of a proximity-based service, so that computing load of the first terminal can be reduced, thereby optimizing computing and transmission efficiency of the first service.

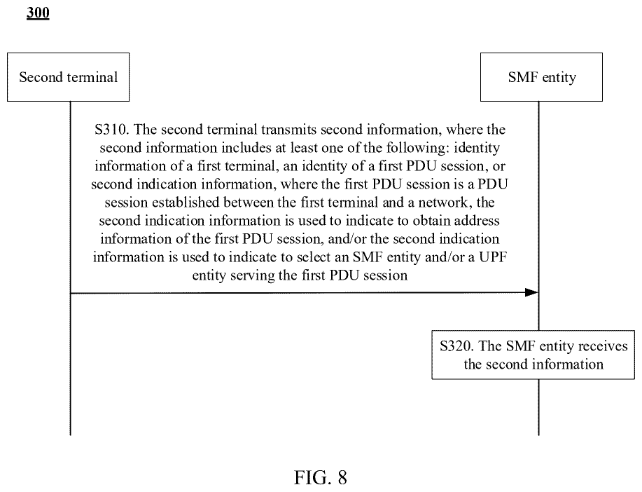

FIG. 8 is a schematic flowchart of a wireless communication method 300 according to an embodiment of this application. As shown in FIG. 8, the wireless communication method 300 may include at least part of following content.

S310. A second terminal transmits second information, where the second information is used to establish or modify a PDU session between the second terminal and a network, and the second information includes at least one of the following: identity information of a first terminal, an identity of a first PDU session, or second indication information, where the first PDU session is a PDU session established between the first terminal and the network, the second indication information is used to indicate to obtain address information of the first PDU session, and/or the second indication information is used to indicate to select an SMF entity and/or a UPF entity serving the first PDU session.

S320. An SMF entity receives the second information.

In this embodiment of this application, the second terminal may support a proximity computing service, that is, the second terminal may provide not only a relay communications service, but also computing power so as to provide a computing service for a task, and send a computing result to an application server.

In some embodiments, the first terminal may be a remote terminal, and the second terminal may be a relay terminal.

In some embodiments, before the second terminal executes the proximity computing service (that is, before the second terminal participates in a computing task), a computing task executed by the first terminal and a computing task executed by the network constitute a first service. Specifically, for example, as shown in FIG. 4, the computing task executed by the first terminal is computing tasks at layers 1 to 15 of an Alexnet model, the computing task executed by the network (that is, an application server) is computing tasks at layers 16 to 24 of the Alexnet model, and the computing tasks at the layers 1 to 24 of the Alexnet model constitute a first task (that is, an image recognition task).

In some embodiments, after the second terminal executes the proximity computing service (that is, after the second terminal participates in a computing task), a computing task executed by the first terminal, a computing task executed by the second terminal, and a computing task executed by the network constitute the first service. Specifically, for example, as shown in FIG. 5, the computing task executed by the first terminal is computing tasks at layers 1 to 4 of an Alexnet model, the computing task executed by the second terminal is computing tasks at layers 5 to 15 of the Alexnet model, the computing task executed by the network (that is, an application server) is computing tasks at layers 16 to 24 of the Alexnet model, and the computing tasks at the layers 1 to 24 of the Alexnet model constitute a first task (that is, an image recognition task).

In some embodiments, the first service may be an image recognition task, a measurement task, a positioning task, or the like. This is not limited in this embodiment of this application.

In some embodiments, the identity information of the first terminal includes at least an identity used by the first terminal in a core network or a layer 2 identity of the first terminal.

In some embodiments, the identity used by the first terminal in the core network may include but is not limited to at least one of the following:
a SUPI, or a 5G-GUTI.

In some embodiments, the first PDU session may be specifically a PDU session requested by the first terminal to be established before the second terminal participates in a computing task and used for transmitting related data of the computing task executed by the first terminal.

In some embodiments, the SMF entity transmits third information, where the third information includes at least the address information of the first PDU session.

In some embodiments, the address information of the first PDU session may be one of the following:
an IP address, an IP v6 address, or a MAC address.

In some embodiments, the second terminal transmits at least one of the following by using the address information of the first PDU session: related data of a computing task executed by the second terminal, or related data, obtained from the first terminal, of a computing task executed by the first terminal.

Specifically, the SMF entity in S320 is the SMF entity serving the first PDU session.

In this embodiment of this application, the second terminal may indicate, by using the second information, to obtain the address information of the first PDU session, and further, the second terminal may transmit at least one of the following by using the address information of the first PDU session: the related data of the computing task executed by the second terminal, or the related data, obtained from the first terminal, of the computing task executed by the first terminal. Specifically, the second terminal transmits related data of a computing task by using the address information of the first PDU session, so as to ensure that address information used when the second terminal transmits the related data of the computing task remains unchanged before and after the second terminal participates in the computing task, and the network can also identify the related data of the computing task and transmitted after the second terminal participates in the computing task.

In some embodiments, load of the computing task executed by the first terminal and load of the computing task executed by the second terminal may be determined by the first terminal and indicated to the second terminal. Alternatively, load of the computing task executed by the first terminal and load of the computing task executed by the second terminal may be determined by the first terminal and the second terminal through negotiation.

In some embodiments, the second information is carried by using one of the following: a PDU session establishment request, or a PDU session modification request.

Specifically, the PDU session establishment procedure may be shown in FIG. 2.

Specifically, for example, the second terminal may request, by transmitting a PDU session establishment request, to establish a new PDU session denoted as a second PDU session. An IP address of the second PDU session is the IP address corresponding to the first PDU session, and the second PDU session is used to transmit at least one of the following: related data of a computing task executed by the second terminal, or related data, obtained from the first terminal, of a computing task executed by the first terminal.

Specifically, for example, the second terminal may request, by transmitting a PDU session establishment request, to establish a new PDU session denoted as a second PDU session. The second PDU session may be a PDU session that is the same as the first PDU session, an IP address corresponding to the second PDU session is the IP address corresponding to the first PDU session, and the second PDU session is used to transmit at least one of the following: related data of a computing task executed by the second terminal, or related data, obtained from the first terminal, of a computing task executed by the first terminal.

Specifically, for another example, the second terminal may request, by transmitting a PDU session modification request, to modify an original PDU session denoted as a third PDU session. An IP address corresponding to the modified third PDU session is the IP address corresponding to the first PDU session, and the modified third PDU session is used to transmit at least one of the following: related data of a computing task executed by the second terminal, or related data, obtained from the first terminal, of a computing task executed by the first terminal.

In some embodiments, in a case that the second information is carried in a PDU session establishment request, the third information is carried in a PDU session establishment response; and/or in a case that the second information is carried in a PDU session modification request, the third information is carried in a PDU session modification response.

In some embodiments, the first terminal triggers release of the first PDU session. That is, after the second terminal participates in the computing task, the first terminal may transmit, by using the second terminal, the related data of the computing task executed by the first terminal. Therefore, the first terminal may trigger release of the first PDU session.

In some embodiments, the SMF entity triggers release of the first PDU session. That is, after the second terminal participates in the computing task, the first terminal may transmit, by using the second terminal, the related data of the computing task executed by the first terminal. Therefore, the SMF may trigger release of the first PDU session.

In some embodiments, before transmitting the second information, the second terminal may further receive first information transmitted by the first terminal, where the first information includes at least one of the following: the identity information of the first terminal, the identity of the first PDU session, or first indication information, where the first indication information is used to indicate the second terminal to execute a proximity computing service.

In some embodiments, in a case that the identity information of the first terminal includes at least the layer 2 identity of the first terminal, the second terminal or a core network device may determine, based on the layer 2 identity of the first terminal, the identity used by the first terminal in the core network.

In this embodiment of this application, the first indication information is used to indicate the second terminal to execute the proximity computing service, and further, the second terminal may trigger a PDU session establishment or modification procedure, and obtain an IP address previously used by the first terminal (that is, the IP address corresponding to the first PDU session). Further, the second terminal transmits related data of a computing task by using the IP address previously used by the first terminal, so as to ensure that an IP address used when the second terminal transmits the related data of the computing task remains unchanged before and after the second terminal participates in the computing task, and the network can also identify the related data of the computing task and transmitted after the second terminal participates in the computing task.

In some embodiments, the first terminal transmits the first information after a discovery procedure, that is, after discovering the second terminal, the first terminal may transmit the first information to the second terminal. Specifically, the discovery procedure may be shown in FIG. 2.

In some embodiments, the first terminal transmits the first information in a process of establishing a sidelink connection to the second terminal. Optionally, for example, the first information is carried by using a direct communication request, that is, the first terminal may carry the first information in the direct communication request transmitted in the process of establishing the sidelink connection to the second terminal.

In some embodiments, the first terminal transmits the first information after establishing a sidelink connection (which may also be referred to as a PC5 connection) to the second terminal. Optionally, for example, the first information is carried by using a PC5 user plane message. Specifically, the PC5 connection establishment procedure may be shown in FIG. 2.

In some embodiments, each computing task of the first service is executed by a first model. Optionally, the first model is an Alexnet model, or the first model is another network model. This is not limited in this embodiment of this application.

In some embodiments, model information of the first model is obtained by the first terminal in a registration process. For example, the model information of the first model is obtained by the first terminal in a process of executing fifth-generation system (5G system, 5GS) registration. Specifically, the 5GS registration process may be shown in FIG. 2.

In some embodiments, model information of the first model is preconfigured by a network device, or model information of the first model is stipulated in a protocol.

In some embodiments, the model information of the first model includes but is not limited to at least one of the following: a model topology and parameter information of the first model, model split point information of the first model, or an amount of intermediate data corresponding to a model split point of the first model.

Specifically, for example, the amount of the intermediate data corresponding to the model split point of the first model may be shown in the foregoing Table 1.

Therefore, in this embodiment of this application, the first terminal transmits the first information. Therefore, the second terminal may indicate, based on content included in the first information, to obtain the address information of the first PDU session, and further, the second terminal may transmit at least one of the following by using the address information of the first PDU session: the related data of the computing task executed by the second terminal, or the related data, obtained from the first terminal, of the computing task executed by the first terminal. Specifically, the second terminal transmits related data of a computing task by using the address information of the first PDU session, so as to ensure that an address used when the second terminal transmits the related data of the computing task remains unchanged before and after the second terminal participates in the computing task, and the network can also identify the related data of the computing task and transmitted after the second terminal participates in the computing task. That is, in a case that the first terminal accesses the network by using the second terminal and the second terminal supports the proximity computing service, for the first service, the second terminal may share a part of computing tasks of the first terminal, and the second terminal may use a sidelink between the second terminal and the first terminal to unload a work task of a proximity-based service, so that computing load of the first terminal can be reduced, thereby optimizing computing and transmission efficiency of the first service.

The following describes the technical solutions in this application in detail by using a specific embodiment.

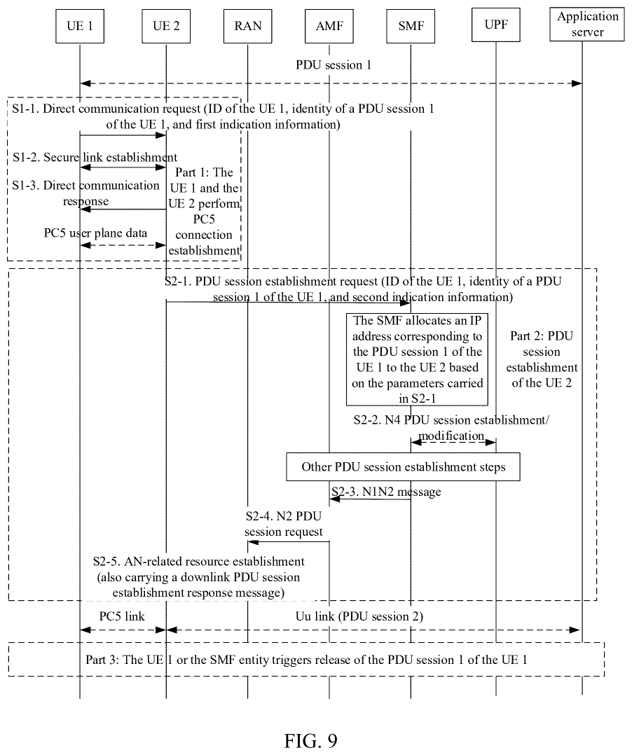

In Embodiment 1, it is assumed that a first terminal is UE 1, a second terminal is UE 2, a first PDU session is a PDU session 1, and address information of the PDU session is an IP address. As shown in FIG. 9, three parts of content may be included. In a first part, the UE 1 performs PC5 connection establishment with the UE 2, which may be specifically implemented by S1-1 to S1-3. In a second part, the UE 2 (that is, relay UE) performs PDU session establishment, which may be specifically implemented by S2-1 to S2-5. In a third part, the UE 1 or an SMF entity triggers a procedure of releasing the PDU session 1 of the UE 1.

As shown in FIG. 9, before the first part, the PDU session 1 is established between the UE 1 and a network, and the UE 1 may transmit related data of a computing task by using the PDU session 1.

S1-1. The UE 1 transmits a direct communication request to the UE 2.

S1-2. A secure link between the UE 1 and the UE 2 is established.

S1-3. The UE 2 transmits a direct communication response to the UE 1.

Optionally, the UE 1 may notify the UE 2 of at least one of the following parameters by using the direct communication request:
an identity (ID) of the UE 1, an identity of the PDU session 1 of the UE 1, or first indication information.

Optionally, the UE 1 may notify the UE 2 of at least one of the following parameters by using a PC5 user plane message:
an identity (ID) of the UE 1, an identity of the PDU session 1 of the UE 1, or first indication information.

The ID of the UE 1 is an ID used by the UE 1 in a core network, for example, a SUPI or a 5G-GUTI, so that a network element in the core network can identify the ID; or the ID of the UE 1 is a layer 2 ID of the UE 1, and then the UE 2 determines, based on the layer 2 ID of the UE 1, an ID used by the UE 1 in a core network. The identity of the PDU session 1 of the UE 1 is an identity of a PDU session currently used by the UE 1 for transmitting data for a first service. The first indication information is used to indicate the UE 2 to execute a “proximity computing service”, and therefore the UE 2 may trigger PDU session establishment in the second part and obtain an IP address previously used by the UE 1.

It should be noted that in the first part, the UE 1 may have a plurality of PDU sessions. The PDU session herein is a PDU session serving data transmission of the first service, and another PDU session may not be affected.

Optionally, in the direct communication request or the PC5 user plane message in the first part, the UE 1 may transmit at least one of the following parameters to the UE 2: information about a computing task executed by the UE 1, information about a computing task executed by the UE 2, a computing time of the computing task executed by the UE 1, and a total service time (including the computing time of the computing task executed by the UE 1, a computing time of the computing task executed by the UE 2, a time for transmitting related data of the computing task executed by the UE 1 and related data of the computing task executed by the UE 2, and a computing time of a computing task executed by the network). Therefore, the UE 2 may determine a QoS parameter of a PC5 interface between the UE 2 and the UE 1 and a QoS parameter of a Uu interface between the UE 2 and a network device. Further, the UE 2 may receive, based on the QOS parameter of the PC5 interface, the related data of the computing task executed by the UE 1, and the UE 2 may transmit, to the network based on the QoS parameter of the Uu interface, the related data of the computing task executed by the UE 1 and the related data of the computing task executed by the UE 2.

S2-1. The UE 2 transmits a PDU session establishment request to the SMF entity, where the PDU session establishment request includes at least one of the following: an ID of the UE 1, an identity of the PDU session 1 of the UE 1, or second indication information. The second indication information is used to indicate to obtain an IP address of the PDU session 1, and/or the second indication information is used to indicate to select an SMF entity serving the PDU session 1. In addition, optionally, a PDU session requested by the UE 2 may carry an identity of a PDU session 2 separately, and the identity of the PDU session 1 of the UE 1 may be used as an identity of the PDU session established by the UE 2.

S2-2. N4 interface-based PDU session establishment/modification is executed between the SMF entity and a UPF entity.

S2-3: The SMF entity transmits an NIN2 message to an AMF entity.

S2-4. The AMF entity transmits an N2 PDU session request to a radio access network (RAN) device.

S2-5. Access network (AN) related resource establishment (a downlink PDU session establishment response is also carried and an IP address corresponding to the PDU session 1 of the UE 1 is included) is executed between the RAN device and the UE 2.

In the second part, after receiving the PDU session establishment request, the SMF entity allocates the IP address of the identity of the PDU session 1 of the UE 1 to the UE 2, and continues to execute another procedure step of the PDU session establishment.

After the second part, the UE 2 may obtain, by using a PC5 link, the related data of the computing task executed by the UE 1, and the UE 2 may transmit, by using the PDU session 2, the related data of the computing task executed by the UE 1 and the related data of the computing task executed by the UE 2.

In the third part, because the IP address corresponding to the PDU session 1 of the UE 1 is already used by the UE 2, the PDU session 1 of the UE 1 needs to be released. The release may be triggered by the SMF entity or the UE 1.

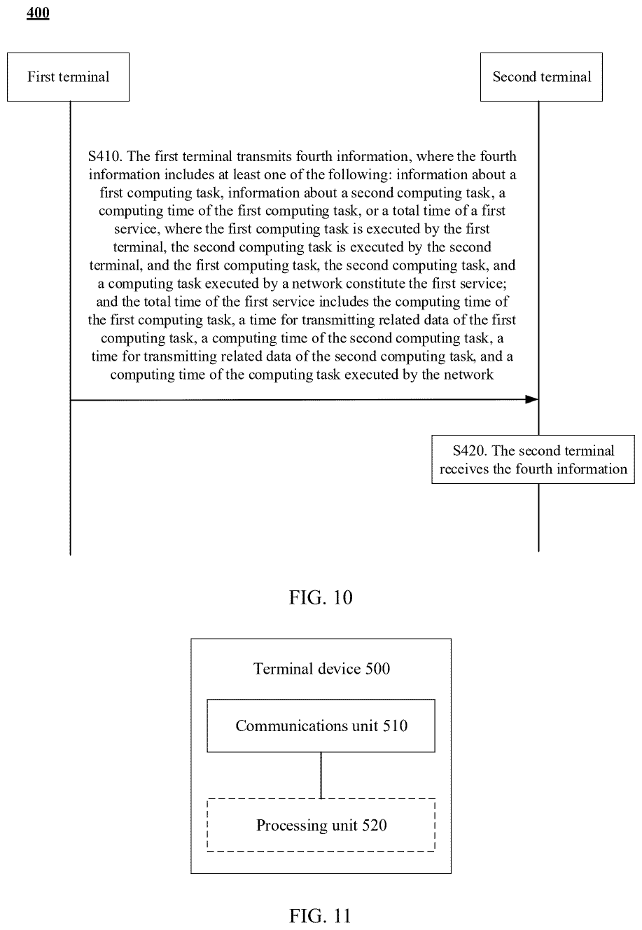

FIG. 10 is a schematic flowchart of a wireless communication method 400 according to an embodiment of this application. A first terminal transmits related data of the first terminal by using a PDU session established between a second terminal and a network. Specifically, as shown in FIG. 10, the wireless communication method 400 may include at least a part of the following content.

S410. The first terminal transmits fourth information, where the fourth information includes at least one of the following: information about a first computing task, information about a second computing task, a computing time of the first computing task, or a total time of a first service, where the first computing task is executed by the first terminal, the second computing task is executed by the second terminal, and the first computing task, the second computing task, and a computing task executed by the network constitute the first service; and the total time of the first service includes the computing time of the first computing task, a time for transmitting related data of the first computing task, a computing time of the second computing task, a time for transmitting related data of the second computing task, and a computing time of the computing task executed by the network.

S420. The second terminal receives the fourth information.

In this embodiment of this application, the second terminal may support a proximity computing service, that is, the second terminal may provide not only a relay communications service, but also computing power so as to provide a computing service for a task, and send a computing result to an application server.

In some embodiments, the first terminal may be a remote terminal, and the second terminal may be a relay terminal.

In some embodiments, before the second terminal executes the proximity computing service (that is, before the second terminal participates in a computing task), a computing task executed by the first terminal and a computing task executed by the network constitute a first service. Specifically, for example, as shown in FIG. 4, the computing task executed by the first terminal is computing tasks at layers 1 to 15 of an Alexnet model, the computing task executed by the network (that is, an application server) is computing tasks at layers 16 to 24 of the Alexnet model, and the computing tasks at the layers 1 to 24 of the Alexnet model constitute a first task (that is, an image recognition task).

In some embodiments, after the second terminal executes the proximity computing service (that is, after the second terminal participates in a computing task), a computing task executed by the first terminal, a computing task executed by the second terminal, and a computing task executed by the network constitute the first service. Specifically, for example, as shown in FIG. 5, the computing task executed by the first terminal is computing tasks at layers 1 to 4 of an Alexnet model, the computing task executed by the second terminal is computing tasks at layers 5 to 15 of the Alexnet model, the computing task executed by the network (that is, an application server) is computing tasks at layers 16 to 24 of the Alexnet model, and the computing tasks at the layers 1 to 24 of the Alexnet model constitute a first task (that is, an image recognition task).

In some embodiments, the first service may be an image recognition task, a measurement task, a positioning task, or the like. This is not limited in this embodiment of this application.

It should be noted that QoS on a PC5 interface and a Uu interface is determined by the relay terminal (that is, the second terminal). Generally, because the relay terminal (that is, the second terminal) provides only a communication service, that is, data transmitted by the remote terminal (that is, the first terminal) is forwarded to a fifth-generation system (5G System, 5GS), QoS parameters of the PC5 interface and the Uu interface are consistent.

However, when the relay terminal (that is, the second terminal) provides not only a communication service but also a computing service (which may also be referred to as a “proximity computing service”), QoS parameter values of different interfaces need to be considered from a perspective of an end-to-end service, because a time for the end-to-end service is determined by a computing time and a communication time of a task in this case.

In this embodiment of this application, in a case that the first terminal accesses the network by using the second terminal and the second terminal supports the proximity computing service, the second terminal may determine a QoS parameter of a PC5 interface between the second terminal and the first terminal and a QoS parameter of a Uu interface between the second terminal and a network device based on information about the computing task executed by the first terminal, a computing time of the computing task executed by the first terminal, information about the computing task executed by the second terminal, a computing time of the computing task executed by the second terminal, and the total time (including a computing time and a transmission time) of the first service. Further, the second terminal may receive, based on the QoS parameter of the PC5 interface, related data of the computing task executed by the first terminal, and the second terminal may transmit, to the network based on the QoS parameter of the Uu interface, the related data of the computing task executed by the first terminal and related data of the computing task executed by the second terminal.

In some embodiments, an IP address used when the second terminal transmits the related data of the first computing task and/or the related data of the second computing task is an IP address of the first terminal. Specifically, the first terminal may transmit the related data of the first computing task to the second terminal by using the PC5 interface. After the second terminal executes the second computing task, the second terminal transmits the related data of the first computing task and/or the related data of the second computing task to the network, and the IP address used when the second terminal transmits the related data of the first computing task and/or the related data of the second computing task is the IP address of the first terminal.

It should be noted that the IP address of the first terminal may be an IP address corresponding to a PDU session requested by the first terminal to be established before the second terminal participates in a computing task and used for transmitting related data of the computing task executed by the first terminal.

Specifically, the second terminal transmits related data of a computing task by using the IP address previously used by the first terminal, so as to ensure that an IP address used when the second terminal transmits the related data of the computing task remains unchanged before and after the second terminal participates in the computing task, and the network can also identify the related data of the computing task and transmitted after the second terminal participates in the computing task.

In some embodiments, the second terminal transmits fifth information, where the fifth information is used to request the IP address of the first terminal, and/or the fifth information is used to indicate the second terminal to execute a proximity computing service.

Specifically, for example, the second terminal transmits the fifth information to an SMF entity, and the SMF may allocate the IP address of the first terminal to the second terminal based on the fifth information.

In some embodiments, the fifth information includes at least one of the following: identity information of the first terminal, and information about a PDU session used when the first terminal transmits related data of a computing task executed by the first terminal. The identity information of the first terminal includes at least an identity used by the first terminal in a core network.

It should be noted that the IP address of the first terminal is an IP address corresponding to a PDU session used when the first terminal transmits the related data of the computing task executed by the first terminal. After learning the information about the PDU session used when the first terminal transmits the related data of the computing task executed by the first terminal, the SMF entity may learn the IP address of the first terminal. Therefore, the SMF may allocate the IP address of the first terminal to the second terminal.

In some embodiments, content included in the fifth information is obtained by the second terminal in a discovery procedure, or content included in the fifth information is obtained by the second terminal in a process of establishing a sidelink connection to the first terminal.

In some embodiments, the fifth information is transmitted by the second terminal in a process of requesting to establish a target PDU session,
where the target PDU session is used to transmit the related data of the first computing task and/or the related data of the second computing task.

In some embodiments, the target PDU session may be a PDU session requested by the first terminal to be established and used for transmitting the related data of the computing task executed by the first terminal, or the target PDU session may be a PDU session that is different from a PDU session requested by the first terminal to be established.

In some embodiments, the fifth information is carried by using one of the following:
a PDU session establishment request, or a PDU session modification request.

Specifically, the PDU session establishment procedure may be shown in FIG. 2.

Specifically, for example, the second terminal may request, by transmitting a PDU session establishment request, to establish a new PDU session, that is, a target PDU session. An IP address corresponding to the target PDU session is the IP address of the first terminal, and the target PDU session is used to transmit at least one of the following: related data of a computing task executed by the second terminal, or related data, obtained from the first terminal, of a computing task executed by the first terminal.

Specifically, for another example, the second terminal may request, by transmitting a PDU session modification request, to modify an original PDU session, and the modified PDU session is a target PDU session. An IP address corresponding to the target PDU session is the IP address of the first terminal, and the target PDU session is used to transmit at least one of the following: related data of a computing task executed by the second terminal, or related data, obtained from the first terminal, of a computing task executed by the first terminal.

In some embodiments, each computing task of the first service is executed by a first model. Optionally, the first model is an Alexnet model, or the first model is another network model. This is not limited in this embodiment of this application.

In some embodiments, the fourth information further includes at least one of the following:
information about the first model, information about at least one model split point of the first model, or information about an amount of corresponding intermediate data.

In some embodiments, model information of the first model is obtained by the second terminal in a registration process. For example, the model information of the first model is obtained by the first terminal in a process of executing fifth-generation system (5G system, 5GS) registration, and the 5GS registration process may be shown in FIG. 2.

In some embodiments, model information of the first model is preconfigured by a network device, or model information of the first model is stipulated in a protocol, or model information of the first model is configured or indicated by the first terminal.

In some embodiments, the model information of the first model includes but is not limited to at least one of the following: a model topology and parameter information of the first model, model split point information of the first model, or an amount of intermediate data corresponding to a model split point of the first model.

In some embodiments, the second terminal determines a quality of service QoS parameter of a PC5 interface between the second terminal and the first terminal and a QoS parameter of a Uu interface between the second terminal and a network device based on the fourth information.

In some embodiments, the second terminal determines the QOS parameter of the PC5 interface between the second terminal and the first terminal and the QoS parameter of the Uu interface between the second terminal and the network device based on the fourth information, the computing time of the second computing task, the at least one model split point of the first model, and the information about the amount of the corresponding intermediate data.

In some embodiments, the first terminal transmits the fourth information after a discovery procedure. In other words, the second terminal receives the fourth information after the discovery procedure. Specifically, the discovery procedure may be shown in FIG. 2.

In some embodiments, the first terminal transmits the fourth information in a process of establishing a sidelink connection to the second terminal. In other words, the second terminal receives the fourth information in a process of establishing a sidelink connection (that is, a PC5 connection) to the first terminal. Specifically, the PC5 connection establishment procedure may be shown in FIG. 2.

In some embodiments, the first terminal transmits the fourth information after establishing a sidelink connection (that is, a PC5 connection) to the second terminal. In other words, the second terminal receives the fourth information after establishing a sidelink connection to the first terminal. Specifically, the PC5 connection establishment procedure may be shown in FIG. 2.

In some embodiments, the first terminal discovers the second terminal based on at least one of the following:
whether the first model is supported, or whether the proximity computing service is supported.

Therefore, in this embodiment of this application, in a case that the first terminal accesses the network by using the second terminal and the second terminal supports the proximity computing service, the second terminal may determine a QoS parameter of a PC5 interface between the second terminal and the first terminal and a QoS parameter of a Uu interface between the second terminal and a network device based on information about the computing task executed by the first terminal, a computing time of the computing task executed by the first terminal, information about the computing task executed by the second terminal, a computing time of the computing task executed by the second terminal, and the total time (including a computing time and a transmission time) of the first service. Further, the second terminal may receive, based on the QoS parameter of the PC5 interface, related data of the computing task executed by the first terminal, and the second terminal may transmit, to the network based on the QoS parameter of the Uu interface, the related data of the computing task executed by the first terminal and related data of the computing task executed by the second terminal. That is, in a case that the first terminal accesses the network by using the second terminal and the second terminal supports the proximity computing service, for the first service, the second terminal may share a part of computing tasks of the first terminal, and the second terminal may use a sidelink between the second terminal and the first terminal to unload a work task of a proximity-based service, so that computing load of the first terminal can be reduced, thereby optimizing computing and transmission efficiency of the first service.

The foregoing describes the method embodiments of this application in detail with reference to FIG. 6 to FIG. 10. The following describes the apparatus embodiments of this application in detail with reference to FIG. 11 to FIG. 16. It should be understood that the apparatus embodiments correspond to the method embodiments. For similar description, reference may be made to the method embodiments.

FIG. 11 is a schematic block diagram of a terminal device 500 according to an embodiment of this application. The terminal device 500 is a first terminal, and the first terminal transmits related data of the first terminal by using a protocol data unit PDU session established between a second terminal and a network. As shown in FIG. 11, the terminal device 500 includes:
a communications unit 510, configured to transmit first information,
where the first information includes at least one of the following: identity information of the first terminal, an identity of a first protocol data unit PDU session, or first indication information,
where the first PDU session is a PDU session established between the first terminal and the network, and the first indication information is used to indicate the second terminal to execute a proximity computing service.

In some embodiments, the communications unit 510 is specifically configured to:
transmit the first information after a discovery procedure, or transmit the first information in a process of establishing a sidelink connection to the second terminal, or transmit the first information after establishing a sidelink connection to the second terminal.

In some embodiments, in a case that the first terminal transmits the first information in the process of establishing the sidelink connection to the second terminal, the first information is carried by using a direct communication request; or
in a case that the first terminal transmits the first information after establishing the sidelink connection to the second terminal, the first information is carried by using a PC5 user plane message.

In some embodiments, before the second terminal executes the proximity computing service, a computing task executed by the first terminal and a computing task executed by the network constitute a first service; or
after the second terminal executes the proximity computing service, a computing task executed by the first terminal, a computing task executed by the second terminal, and a computing task executed by the network constitute a first service.

In some embodiments, an address used when the second terminal transmits related data of the computing task executed by the second terminal and/or related data of the computing task executed by the first terminal is address information of the first PDU session.

In some embodiments, each computing task of the first service is executed by a first model.

In some embodiments, model information of the first model is obtained by the first terminal in a registration process.

In some embodiments, the model information of the first model is obtained by the first terminal in a process of executing fifth-generation system 5GS registration.

In some embodiments, model information of the first model is preconfigured by a network device, or model information of the first model is stipulated in a protocol.

In some embodiments, the model information of the first model includes at least one of the following: a model topology and parameter information of the first model, model split point information of the first model, or an amount of intermediate data corresponding to a model split point of the first model.

In some embodiments, the terminal device 500 further includes:
a processing unit 520, configured to discover the second terminal based on at least one of the following:
whether the first model is supported, or whether the proximity computing service is supported.

In some embodiments, the terminal device 500 further includes:
a processing unit 520, configured to trigger release of the first PDU session.

In some embodiments, the identity information of the first terminal includes at least an identity used by the first terminal in a core network or a layer 2 identity of the first terminal.

In some embodiments, the foregoing communications unit may be a communications interface or a transceiver, or an input/output interface of a communications chip or a system on chip. The processing unit may be one or more processors.

It should be understood that the terminal device 500 according to this embodiment of this application may correspond to a first terminal in method embodiments of this application, and the foregoing and other operations and/or functions of units in the terminal device 500 are respectively used to implement corresponding procedures of the first terminal in the methods shown in FIG. 6 to FIG. 8. For brevity, details are not described herein again.

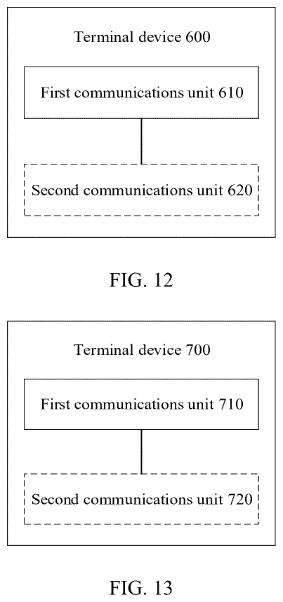

FIG. 12 is a schematic block diagram of a terminal device 600 according to an embodiment of this application. The terminal device 600 is a second terminal, and a first terminal transmits related data of the first terminal by using a protocol data unit PDU session established between the second terminal and a network. As shown in FIG. 12, the terminal device 600 includes:
a first communications unit 610, configured to receive first information,
where the first information includes at least one of the following: identity information of the first terminal, an identity of a first protocol data unit PDU session, or first indication information,
where the first PDU session is a PDU session established between the first terminal and the network, and the first indication information is used to indicate the second terminal to execute a proximity computing service.

In some embodiments, the first communications unit 610 is specifically configured to:
receive the first information after a discovery procedure, or receive the first information in a process of establishing a sidelink connection to the first terminal, or receive the first information after a sidelink connection to the first terminal is established.

In some embodiments, in a case that the second terminal receives the first information in the process of establishing the sidelink connection to the first terminal, the first information is carried by using a direct communication request; or
in a case that the second terminal receives the first information after establishing the sidelink connection to the first terminal, the first information is carried by using
a PC5 user plane message.

In some embodiments, the terminal device 600 further includes:
a second communications unit 620, configured to transmit second information,
where the second information is used to establish or modify the PDU session between the second terminal and the network, and the second information includes at least one of the following: the identity information of the first terminal, the identity of the first PDU session, or second indication information,
where the second indication information is used to indicate to obtain address information of the first PDU session, and/or the second indication information is used to indicate to select a session management function SMF entity and/or a user plane function UPF entity serving the first PDU session.

In some embodiments, the second information is carried by using one of the following:
a PDU session establishment request, or a PDU session modification request.

In some embodiments, the first communications unit 610 is further configured to receive third information, where the third information includes at least the address information of the first PDU session.

The second communications unit 620 is further configured to transmit at least one of the following by using the address information of the first PDU session: related data of a computing task executed by the second terminal, or related data, obtained from the first terminal, of a computing task executed by the first terminal.

In some embodiments, in a case that the second information is carried in a PDU session establishment request, the third information is carried in a PDU session establishment response; and/or in a case that the second information is carried in a PDU session modification request, the third information is carried in a PDU session modification response.

In some embodiments, before the second terminal executes the proximity computing service, a computing task executed by the first terminal and a computing task executed by the network constitute a first service; or
after the second terminal executes the proximity computing service, a computing task executed by the first terminal, a computing task executed by the second terminal,
and a computing task executed by the network constitute a first service.

In some embodiments, each computing task of the first service is executed by a first model.

In some embodiments, model information of the first model is obtained by the second terminal in a registration process.

In some embodiments, the model information of the first model is obtained by the second terminal in a process of executing fifth-generation system 5GS registration.

In some embodiments, model information of the first model is preconfigured by a network device, or model information of the first model is stipulated in a protocol.

In some embodiments, the model information of the first model includes at least one of the following: a model topology and parameter information of the first model, model split point information of the first model, or an amount of intermediate data corresponding to a model split point of the first model.

In some embodiments, the identity information of the first terminal includes at least an identity used by the first terminal in a core network or a layer 2 identity of the first terminal.

In some embodiments, the foregoing communications unit may be a communications interface or a transceiver, or an input/output interface of a communications chip or a system on chip.

It should be understood that the terminal device 600 according to this embodiment of this application may correspond to a second terminal in method embodiments of this application, and the foregoing and other operations and/or functions of units in the terminal device 600 are respectively used to implement corresponding procedures of the second terminal in the methods shown in FIG. 6 to FIG. 8. For brevity, details are not described herein again.

FIG. 13 is a schematic block diagram of a terminal device 700 according to an embodiment of this application. The terminal device 700 is a second terminal. As shown in FIG. 13, the terminal device 700 includes:
a first communications unit 710, configured to transmit second information,
where the second information includes at least one of the following: identity information of a first terminal, an identity of a first PDU session, or second indication information,
where the first PDU session is a PDU session established between the first terminal and a network, the second indication information is used to indicate to obtain address information of the first PDU session, and/or the second indication information is used to indicate to select a session management function SMF entity and/or a user plane function UPF entity serving the first PDU session.

In some embodiments, the second information is carried by using one of the following:
a PDU session establishment request, or a PDU session modification request.

In some embodiments, the terminal device 700 further includes a second communications unit 720.

The second communications unit 720 is configured to receive third information, where the third information includes at least the address information of the first PDU session.

The first communications unit 710 is further configured to transmit at least one of the following by using the address information of the first PDU session: related data of a computing task executed by the second terminal, or related data, obtained from the first terminal, of a computing task executed by the first terminal.

In some embodiments, in a case that the second information is carried in a PDU session establishment request, the third information is carried in a PDU session establishment response; and/or in a case that the second information is carried in a PDU session modification request, the third information is carried in a PDU session modification response.

In some embodiments, the terminal device 700 further includes a second communications unit 720.

The second communications unit 720 is configured to receive first information,
where the first information includes at least one of the following: the identity information of the first terminal, the identity of the first PDU session, or first indication information,
where the first indication information is used to indicate the second terminal to execute a proximity computing service.

In some embodiments, the second communications unit 720 is specifically configured to:
receive the first information after a discovery procedure, or receive the first information in a process of establishing a sidelink connection to the first terminal, or receive the first information after a sidelink connection to the first terminal is established.

In some embodiments, in a case that the second terminal receives the first information in the process of establishing the sidelink connection to the first terminal, the first information is carried by using a direct communication request; or
in a case that the second terminal receives the first information after establishing the sidelink connection to the first terminal, the first information is carried by using a PC5 user plane message.

In some embodiments, the identity information of the first terminal includes at least an identity used by the first terminal in a core network or a layer 2 identity of the first terminal.

In some embodiments, the foregoing communications unit may be a communications interface or a transceiver, or an input/output interface of a communications chip or a system on chip.

It should be understood that the terminal device 700 according to this embodiment of this application may correspond to a second terminal in method embodiments of this application, and the foregoing and other operations and/or functions of units in the terminal device 700 are respectively used to implement corresponding procedures of the second terminal in the methods shown in FIG. 6 to FIG. 8. For brevity, details are not described herein again.

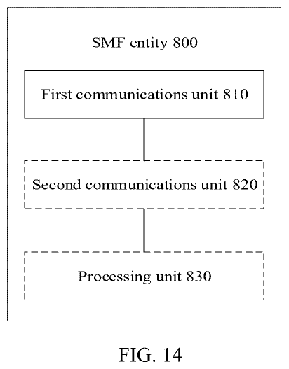

FIG. 14 is a schematic block diagram of an SMF entity 800 according to an embodiment of this application. As shown in FIG. 14, the SMF entity 800 includes:
a first communications unit 810, configured to receive second information,
where the second information includes at least one of the following: identity information of a first terminal, an identity of a first protocol data unit PDU session, or second indication information,
where the first PDU session is a PDU session established between the first terminal and a network, the second indication information is used to indicate to obtain address information of the first PDU session, and/or the second indication information is used to indicate to select an SMF entity and/or a user plane function UPF entity serving the first PDU session.

In some embodiments, the second information is carried by using one of the following:
a PDU session establishment request, or a PDU session modification request.

In some embodiments, the SMF entity 800 further includes:
a second communications unit 820, configured to transmit third information, where the third information includes at least the address information of the first PDU session,
where an address used when the second terminal transmits related data of a computing task executed by the second terminal and/or related data of a computing task executed by the first terminal is the address information of the first PDU session.

In some embodiments, in a case that the second information is carried in a PDU session establishment request, the third information is carried in a PDU session establishment response; and/or in a case that the second information is carried in a PDU session modification request, the third information is carried in a PDU session modification response.

In some embodiments, the SMF entity 800 further includes:
a processing unit 830, configured to trigger release of the first PDU session.

In some embodiments, the identity information of the first terminal includes at least an identity used by the first terminal in a core network or a layer 2 identity of the first terminal.

In some embodiments, the foregoing communications unit may be a communications interface or a transceiver, or an input/output interface of a communications chip or a system on chip. The processing unit may be one or more processors.

It should be understood that the SMF entity 800 according to this embodiment of this application may correspond to an SMF entity in method embodiments of this application, and the foregoing and other operations and/or functions of units in the SMF entity 800 are respectively used to implement corresponding procedures of the SMF entity in the methods shown in FIG. 6 to FIG. 8. For brevity, details are not described herein again.

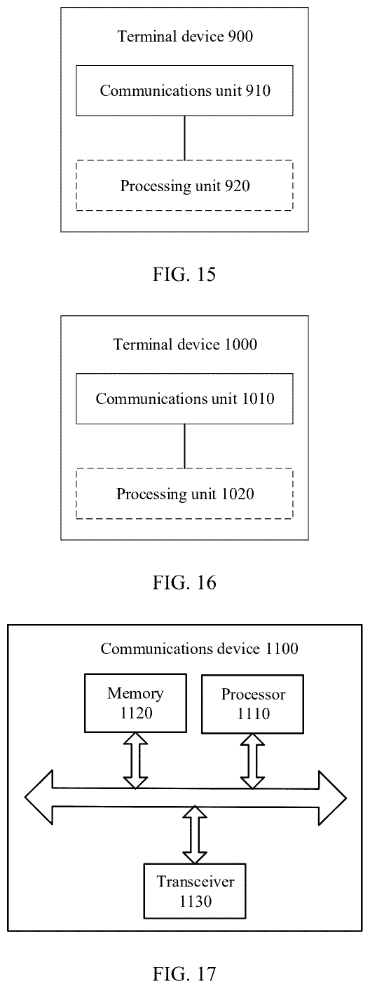

FIG. 15 is a schematic block diagram of a terminal device 900 according to an embodiment of this application. The terminal device 900 is a first terminal, and the first terminal transmits related data of the first terminal by using a protocol data unit PDU session established between a second terminal and a network. As shown in FIG. 15, the terminal device 900 includes:
a communications unit 910, configured to transmit fourth information,
where the fourth information includes at least one of the following: information about a first computing task, information about a second computing task, a computing time of the first computing task, or a total time of a first service,
where the first computing task is executed by the first terminal, the second computing task is executed by the second terminal, and the first computing task, the second computing task, and a computing task executed by the network constitute the first service; and
the total time of the first service includes the computing time of the first computing task, a time for transmitting related data of the first computing task, a computing time of the second computing task, a time for transmitting related data of the second computing task, and a computing time of the computing task executed by the network.

In some embodiments, an internet protocol IP address used when the second terminal transmits the related data of the first computing task and/or the related data of the second computing task is an IP address of the first terminal.

In some embodiments, each computing task of the first service is executed by a first model.

In some embodiments, the fourth information further includes at least one of the following:
information about the first model, information about at least one model split point of the first model, or information about an amount of corresponding intermediate data.

In some embodiments, model information of the first model is obtained by the first terminal in a registration process.

In some embodiments, the model information of the first model is obtained by the first terminal in a process of executing fifth-generation system 5GS registration.

In some embodiments, model information of the first model is preconfigured by a network device, or model information of the first model is stipulated in a protocol.

In some embodiments, the model information of the first model includes at least one of the following: a model topology and parameter information of the first model, model split point information of the first model, or an amount of intermediate data corresponding to a model split point of the first model.

In some embodiments, the terminal device 900 further includes:
a processing unit 920, configured to discover the second terminal based on at least one of the following:
whether the first model is supported, or whether a proximity computing service is supported.

In some embodiments, the communications unit 910 is specifically configured to:
transmit the fourth information after a discovery procedure, or transmit the fourth information in a process of establishing a sidelink connection to the second terminal, or transmit the fourth information after a sidelink connection to the second terminal is established.

In some embodiments, the foregoing communications unit may be a communications interface or a transceiver, or an input/output interface of a communications chip or a system on chip. The processing unit may be one or more processors.

It should be understood that the terminal device 900 according to this embodiment of this application may correspond to a first terminal in method embodiments of this application, and the foregoing and other operations and/or functions of units in the terminal device 900 are respectively used to implement corresponding procedures of the first terminal in the method 300 shown in FIG. 10. For brevity, details are not described herein again.

FIG. 16 is a schematic block diagram of a terminal device 1000 according to an embodiment of this application. The terminal device 1000 is a second terminal, and a first terminal transmits related data of the first terminal by using a protocol data unit PDU session established between the second terminal and a network. As shown in FIG. 16, the terminal device 1000 includes:
a communications unit 1010, configured to receive fourth information,
where the fourth information includes at least one of the following: information about a first computing task, information about a second computing task, a computing time of the first computing task, or a total time of a first service,
where the first computing task is executed by the first terminal, the second computing task is executed by the second terminal, and the first computing task, the second computing task, and a computing task executed by the network constitute the first service; and
the total time of the first service includes the computing time of the first computing task, a time for transmitting related data of the first computing task, a computing time of the second computing task, a time for transmitting related data of the second computing task, and a computing time of the computing task executed by the network.

In some embodiments, an internet protocol IP address used when the second terminal transmits the related data of the first computing task and/or the related data of the second computing task is an IP address of the first terminal.

In some embodiments, the communications unit 1010 is further configured to transmit fifth information,
where the fifth information is used to request the IP address of the first terminal, and/or the fifth information is used to indicate the second terminal to execute a proximity computing service.

In some embodiments, the fifth information includes at least one of the following: identity information of the first terminal, and information about a protocol data unit PDU session used when the first terminal transmits related data of a computing task executed by the first terminal.

In some embodiments, content included in the fifth information is obtained by the second terminal in a discovery procedure, or content included in the fifth information is obtained by the second terminal in a process of establishing a sidelink connection to the first terminal.

In some embodiments, the fifth information is transmitted by the second terminal in a process of requesting to establish a target PDU session,
where the target PDU session is used to transmit the related data of the first computing task and/or the related data of the second computing task.

In some embodiments, the fifth information is carried by using one of the following:
a PDU session establishment request, or a PDU session modification request.

In some embodiments, each computing task of the first service is executed by a first model.

In some embodiments, the fourth information further includes at least one of the following:
information about the first model, information about at least one model split point of the first model, or information about an amount of corresponding intermediate data.

In some embodiments, model information of the first model is obtained by the second terminal in a registration process.

In some embodiments, the model information of the first model is obtained by the second terminal in a process of executing fifth-generation system 5GS registration.

In some embodiments, model information of the first model is preconfigured by a network device, or model information of the first model is stipulated in a protocol, or model information of the first model is configured or indicated by the first terminal.

In some embodiments, the model information of the first model includes at least one of the following: a model topology and parameter information of the first model, model split point information of the first model, or an amount of intermediate data corresponding to a model split point of the first model.

In some embodiments, the terminal device 1000 further includes:
a processing unit 1020, configured to determine a quality of service QoS parameter of a PC5 interface between the second terminal and the first terminal and a QoS parameter of a Uu interface between the second terminal and a network device based on the fourth information.

In some embodiments, the processing unit 1020 is specifically configured to:
determine the QoS parameter of the PC5 interface between the second terminal and the first terminal and the QoS parameter of the Uu interface between the second terminal and the network device based on the fourth information, the computing time of the second computing task, at least one model split point of a first model, and information about an amount of corresponding intermediate data.

In some embodiments, the communications unit 1010 is specifically configured to:
receive the fourth information after a discovery procedure, or receive the fourth information in a process of establishing a sidelink connection to the first terminal, or receive the fourth information after a sidelink connection to the first terminal is established.

In some embodiments, the foregoing communications unit may be a communications interface or a transceiver, or an input/output interface of a communications chip or a system on chip. The processing unit may be one or more processors.

It should be understood that the terminal device 1000 according to this embodiment of this application may correspond to a second terminal in method embodiments of this application, and the foregoing and other operations and/or functions of units in the terminal device 1000 are respectively used to implement corresponding procedures of the second terminal in the method 300 shown in FIG. 10. For brevity, details are not described herein again.

FIG. 17 is a schematic structural diagram of a communications device 1100 according to an embodiment of this application. The communications device 1100 shown in FIG. 17 includes a processor 1110, and the processor 1110 may invoke and run a computer program in a memory to implement a method in embodiments of this application.

In some embodiments, as shown in FIG. 17, the communications device 1100 may further include a memory 1120. The processor 1110 may invoke and run a computer program in the memory 1120 to implement a method in embodiments of this application.

The memory 1120 may be a separate component independent of the processor 1110, or may be integrated into the processor 1110.

In some embodiments, as shown in FIG. 17, the communications device 1100 may further include a transceiver 1130. The processor 1110 may control the transceiver 1130 to communicate with another device, and specifically, may transmit information or data to the another device, or receive information or data transmitted by the another device.

The transceiver 1130 may include a transmitter and a receiver. The transceiver 1130 may further include an antenna, and there may be one or more antennas.

In some embodiments, the processor 1110 may implement a function of a processing unit in the terminal device, or the processor 1110 may implement a function of a processing unit in the network device. For brevity, details are not described herein again.

In some embodiments, the transceiver 1130 may implement a function of a communications unit in the terminal device. For brevity, details are not described herein again.

In some embodiments, the transceiver 1130 may implement a function of a communications unit in the SMF entity. For brevity, details are not described herein again.

In some embodiments, the communications device 1100 may be specifically an SMF entity in embodiments of this application, and the communications device 1100 may implement corresponding procedures implemented by the SMF entity in the methods in embodiments of this application. For brevity, details are not described herein again.

In some embodiments, specifically, the communications device 1100 may be a terminal device in embodiments of this application; and the communications device 1100 may implement corresponding procedures implemented by the terminal device in the methods in embodiments of this application. For brevity, details are not described herein again.

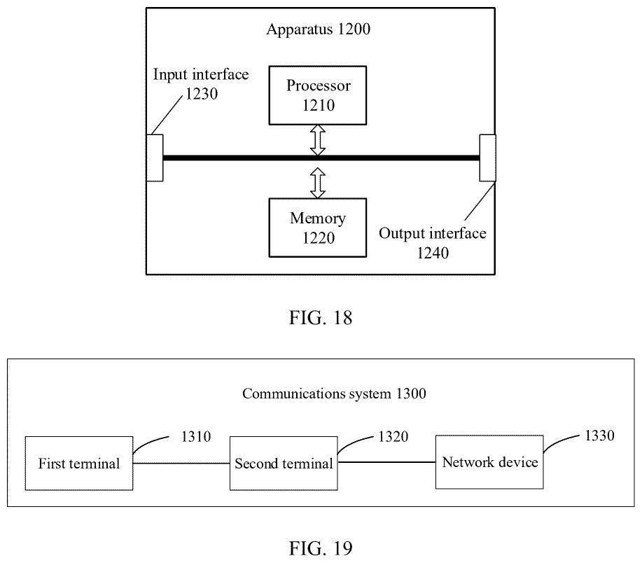

FIG. 18 is a schematic structural diagram of an apparatus according to an embodiment of this application. The apparatus 1200 shown in FIG. 18 includes a processor 1210, and the processor 1210 may invoke and run a computer program in a memory to implement a method in embodiments of this application.

In some embodiments, as shown in FIG. 18, the apparatus 1200 may further include a memory 1220. The processor 1210 may invoke and run a computer program in the memory 1220 to implement a method in embodiments of this application.

The memory 1220 may be a separate component independent of the processor 1210, or may be integrated into the processor 1210.

In some embodiments, the apparatus 1200 may further include an input interface 1230. The processor 1210 may control the input interface 1230 to communicate with another device or chip, and specifically, may obtain information or data transmitted by the another device or chip. Optionally, the processor 1210 may be on or off a chip.

In some embodiments, the processor 1210 may implement a function of a processing unit in the terminal device, or the processor 1210 may implement a function of a processing unit in the SMF entity. For brevity, details are not described herein again.

In some embodiments, the input interface 1230 may implement a function of a communications unit in the terminal device, or the input interface 1230 may implement a function of a communications unit in the SMF entity.

In some embodiments, the apparatus 1200 may further include an output interface 1240. The processor 1210 may control the output interface 1240 to communicate with another device or chip, and specifically, may output information or data to the another device or chip. Optionally, the processor 1210 may be on or off a chip.

In some embodiments, the output interface 1240 may implement a function of a communications unit in the terminal device, or the output interface 1240 may implement a function of a communications unit in the SMF entity.

In some embodiments, the apparatus may be applied to an SMF entity in embodiments of this application, and the apparatus may implement corresponding procedures implemented by the SMF entity in the methods in embodiments of this application. For brevity, details are not described herein again.

In some embodiments, the apparatus may be applied to a terminal device in embodiments of this application; and the apparatus may implement corresponding procedures implemented by the terminal device in the methods in embodiments of this application. For brevity, details are not described herein again.

In some embodiments, the apparatus mentioned in this embodiment of this application may alternatively be a chip, for example, may be a system-level chip, a system chip, a chip system, or a system-on-chip.

FIG. 19 is a schematic block diagram of a communications system 1300 according to an embodiment of this application. As shown in FIG. 19, the communications system 1300 includes a first terminal 1310, a second terminal 1320, and a network device 1330.

The first terminal 1310 may be configured to implement a corresponding function implemented by the first terminal in the foregoing method, the second terminal 1320 may be configured to implement a corresponding function implemented by the second terminal in the foregoing method, and the network device 1330 may be configured to implement a corresponding function implemented by the SMF entity in the foregoing method. For brevity, details are not described herein again.

It should be understood that the processor in this embodiment of this application may be an integrated circuit chip having a signal processing capability. In an implementation process, the steps in the foregoing method embodiments may be implemented by using an integrated logic circuit of hardware of the processor or instructions in a software form. The processor may be a general-purpose processor, a digital signal processor (DSP), an application specific integrated circuit (ASIC), a field programmable gate array (FPGA) or another programmable logic device, a discrete gate or a transistor logic device, or a discrete hardware component. The processor may implement or execute the methods, steps, and logical block diagrams disclosed in embodiments of this application. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, such as a random access memory, a flash memory, a read-only memory, a programmable read-only memory, an electrically erasable programmable memory, or a register. The storage medium is located in the memory. The processor reads information in the memory and completes the steps of the foregoing methods in combination with hardware thereof.

It may be understood that, in embodiments of this application, the memory may be a volatile memory or a non-volatile memory, or may include both a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), and is used as an external cache. By way of example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DR RAM). It should be noted that, the memory in the systems and methods described in this specification includes but is not limited to these memories and any memory of another proper type.

It should be understood that, by way of example but not limitative description, for example, the memory in embodiments of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synch link DRAM, SLDRAM), a direct rambus random access memory (Direct Rambus RAM, DR RAM), or the like. In other words, the memory in embodiments of this application includes but is not limited to these memories and any other proper types of memories.

An embodiment of this application further provides a computer-readable storage medium, configured to store a computer program.

In some embodiments, the computer-readable storage medium may be applied to an SMF entity in embodiments of this application, and the computer program causes a computer to execute corresponding procedures implemented by the SMF entity in the methods in embodiments of this application. For brevity, details are not described herein again.

In some embodiments, the computer-readable storage medium may be applied to the terminal device in embodiments of this application; and the computer program causes a computer to execute corresponding procedures implemented by the terminal device in the methods in embodiments of this application. For brevity, details are not described herein again.

An embodiment of this application further provides a computer program product, including computer program instructions.

In some embodiments, the computer program product may be applied to an SMF entity in embodiments of this application, and the computer program instructions cause a computer to execute corresponding procedures implemented by the SMF entity in the methods in embodiments of this application. For brevity, details are not described herein again.

In some embodiments, the computer program product may be applied to the terminal device in embodiments of this application; and the computer program instructions cause a computer to execute corresponding procedures implemented by the terminal device in the methods in embodiments of this application. For brevity, details are not described herein again.

An embodiment of this application further provides a computer program.

In some embodiments, the computer program may be applied to an SMF entity in embodiments of this application. When being run on a computer, the computer program causes the computer to execute corresponding procedures implemented by the SMF entity in the methods in embodiments of this application. For brevity, details are not described herein again.

In some embodiments, the computer program may be applied to the terminal device in embodiments of this application. When being run on a computer, the computer program causes the computer to execute corresponding procedures implemented by the terminal device in the methods in embodiments of this application. For brevity, details are not described herein again.

A person of ordinary skill in the field may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by persons skilled in the art that, for convenient and brief description, for a detailed working process of the foregoing system, apparatus, and unit, reference may be made to corresponding processes in the foregoing method embodiments, and details are not described herein again.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented as indirect couplings or communication connections through some interfaces, apparatuses or units, and may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objective of the solutions of embodiments.

In addition, functional units in embodiments of this application may be integrated into one processing unit, or each of the units may exist alone physically, or two or more units may be integrated into one unit.

When the functions are implemented in a form of a software functional unit and sold or used as an independent product, the functions may be stored in a computer-readable storage medium. For such understanding, the technical solutions in this application essentially, or the part contributing to the prior art, or some of the technical solutions may be implemented in a form of a software product. The computer software product is stored in a storage medium and includes several instructions for instructing a computer device (which may be a personal computer, a server, a network device, or the like) to execute all or some of the steps of the methods in embodiments of this application. The foregoing storage medium includes various media that may store a program code, such as a USB flash drive, a mobile hard disk, a read-only memory (ROM), a random access memory (RAM), a magnetic disk, or an optical disk.

The foregoing descriptions are merely specific implementations of this application, but the protection scope of this application is not limited thereto. Any variation or replacement readily figured out by persons skilled in the art within the technical scope disclosed in this application shall fall within the protection scope of this application. Therefore, the protection scope of this application should be subject to the protection scope of the claims.

What is claimed is:

1. A terminal device, wherein the terminal device is a first terminal, the first terminal transmits related data of the first terminal by using a protocol data unit (PDU) session established between a second terminal and a network, and the terminal device comprises a processor and a memory, wherein the memory is configured to store a computer program, and the processor is configured to execute the computer program stored in the memory to cause the terminal device to perform a method of:
transmitting first information,
wherein the first information comprises at least one of following: identity information of the first terminal, an identity of a first PDU session, or first indication information,
wherein the first PDU session is a PDU session established between the first terminal and the network, and the first indication information is used to indicate the second terminal to execute a proximity computing service.

2. The terminal device according to claim 1,
wherein the transmitting first information comprises:
transmitting the first information after a discovery procedure, or transmitting the first information in a process of establishing a sidelink connection to the second terminal, or transmitting the first information after establishing a sidelink connection to the second terminal.

3. The terminal device according to claim 2,
wherein in a case that the first terminal transmits the first information in the process of establishing the sidelink connection to the second terminal, the first information is carried by using a direct communication request; or
in a case that the first terminal transmits the first information after establishing the sidelink connection to the second terminal, the first information is carried by using a PC5 user plane message.

4. The terminal device according to claim 1,
wherein before the second terminal executes the proximity computing service, a computing task executed by the first terminal and a computing task executed by the network constitute a first service; or
after the second terminal executes the proximity computing service, a computing task executed by the first terminal, a computing task executed by the second terminal, and a computing task executed by the network constitute a first service.

5. The terminal device according to claim 4,
wherein an address used when the second terminal transmits related data of the computing task executed by the second terminal and/or related data of the computing task executed by the first terminal is address information of the first PDU session.

6. The terminal device according to claim 4,
wherein each computing task of the first service is executed by a first model.

7. The terminal device according to claim 6, wherein the processor is further configured to execute the computer program stored in the memory to cause the terminal device to perform a method of:
discovering the second terminal based on at least one of following:
whether the first model is supported, or whether the proximity computing service is supported.

8. The terminal device according to claim 1, wherein the processor is further configured to execute the computer program stored in the memory to cause the terminal device to perform a method of:
triggering release of the first PDU session.

9. The terminal device according to claim 1, wherein the identity information of the first terminal comprises at least an identity used by the first terminal in a core network or a layer 2 identity of the first terminal.

10. A terminal device, wherein the terminal device is a second terminal, a first terminal transmits related data of the first terminal by using a protocol data unit (PDU) session established between the second terminal and a network, and the terminal device comprises a processor and a memory, wherein the memory is configured to store a computer program, and the processor is configured to execute the computer program stored in the memory to cause the terminal device to perform a method of:
receiving first information,
wherein the first information comprises at least one of following: identity information of the first terminal, an identity of a first PDU session, or first indication information,
wherein the first PDU session is a PDU session established between the first terminal and the network, and the first indication information is used to indicate the second terminal to execute a proximity computing service.

11. The terminal device according to claim 10,
wherein the receiving first information comprises:
receiving the first information after a discovery procedure, or receiving the first information in a process of establishing a sidelink connection to the first terminal, or receiving the first information after establishing a sidelink connection to the first terminal.

12. The terminal device according to claim 11,
wherein in a case that the second terminal receives the first information in the process of establishing the sidelink connection to the first terminal, the first information is carried by using a direct communication request; or
in a case that the second terminal receives the first information after establishing the sidelink connection to the first terminal, the first information is carried by using a PC5 user plane message.

13. The terminal device according to claim 10, wherein the processor is further configured to execute the computer program stored in the memory to cause the terminal device to perform a method of:
transmitting second information,
wherein the second information is used to establish or modify the PDU session between the second terminal and the network, and the second information comprises at least one of following: the identity information of the first terminal, the identity of the first PDU session, or second indication information,
wherein the second indication information is used to indicate to obtain address information of the first PDU session, and/or the second indication information is used to indicate to select a session management function SMF entity and/or a user plane function UPF entity serving the first PDU session.

14. The terminal device according to claim 13, wherein the second information is carried by using one of following:
a PDU session establishment request, or a PDU session modification request.

15. The terminal device according to claim 13, wherein the processor is further configured to execute the computer program stored in the memory to cause the terminal device to perform a method of:
receiving third information, wherein the third information comprises at least the address information of the first PDU session; and
transmitting at least one of following by using the address information of the first PDU session: related data of a computing task executed by the second terminal, or related data, obtained from the first terminal, of a computing task executed by the first terminal.

16. The terminal device according to claim 15, wherein in a case that the second information is carried in a PDU session establishment request, the third information is carried in a PDU session establishment response; and/or in a case that the second information is carried in a PDU session modification request, the third information is carried in a PDU session modification response.

17. The terminal device according to claim 10,
wherein before the second terminal executes the proximity computing service, a computing task executed by the first terminal and a computing task executed by the network constitute a first service; or
after the second terminal executes the proximity computing service, a computing task executed by the first terminal, a computing task executed by the second terminal, and a computing task executed by the network constitute a first service.

18. The terminal device according to claim 17,
wherein each computing task of the first service is executed by a first model.

19. The terminal device according to claim 10, wherein the identity information of the first terminal comprises at least an identity used by the first terminal in a core network or a layer 2 identity of the first terminal.

20. A wireless communication method, applied to a first terminal, wherein the first terminal transmits related data of the first terminal by using a protocol data unit (PDU) session established between a second terminal and a network, and the method comprises:
transmitting, by the first terminal, first information,
wherein the first information comprises at least one of following: identity information of the first terminal, an identity of a first PDU session, or first indication information,
wherein the first PDU session is a PDU session established between the first terminal and the network, and the first indication information is used to indicate the second terminal to execute a proximity computing service.
